(19) United States
(12) Patent Application Publication
(10) Pub. No.: US 2006/0099524 A1
(43) Pub. Date: May 11, 2006

(54) Organic photoreceptor, an image forming method and an image forming apparatus employing the same

(75) Inventor: Shigeki Takenouchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA BUSINESS TECHNOLOGIES, INC., Tokyo (JP)

(21) Appl. No.: 10/984,350

(22) Filed: Nov. 8, 2004

(51) Int. Cl. G03G 5/147; G03G 21/00

(52) U.S. Cl. 430/56; 430/60; 430/125

(57) ABSTRACT

In an organic photoreceptor provide with a covering layer on a base body, a layer thickness deviation of a substantial image forming area of the covering layer is 0.2-2.0 μm, and a relationship between mean value PWS of reflected light amount power spectrum in a range of spatial frequency 0-2 mm⁻¹ measured with exposure wavelength 680 nm and mean value P of an amount of reflected light satisfies the following expression 1:
0<(PWS/P²)<5.0×10⁻⁴ mm⁻¹

### FIELD OF THE INVENTION

The present invention relates to an organic photoreceptor, an image forming method and an image forming apparatus which are used in an electrophotographic copying machine and a printer.

### RELATED ART

In recent years, an image carrier wherein an organic photoreceptor (hereinafter referred to simply as a photoreceptor) containing an organic photoconductive substance is formed to be a thin film on a conductive base body is used most broadly as an image carrier used in an electrophotographic image forming apparatus. Advantages of the organic photoreceptor compared with other photoreceptors include that materials for various types of light sources for exposure covering from visible rays to infrared rays can easily be developed, materials causing no environmental pollution can be selected and manufacturing cost is low.

On the other hand, with respect to the electrophotographic image forming method, the recent progress of digital technologies makes an image forming of a digital mode to be the main trend. In the image forming method of a digital mode, a microscopic dot image of one pixel on the level of 400 dpi (dpi means the number of dots per 1 inch=2.54 cm) is widely visualized by using light of a single wavelength of a laser (LD) or a light emitting diode (LED), and technologies for high image quality which reproduce these microscopic dot images on a high fidelity basis are demanded.

When a thin film formed on a conductive base body such as aluminum which usually generates reflected light is irradiated with image-wise exposure light of LD or LED, an interference effect caused by an optical path difference between a beam that enters and is absorbed directly and a beam that enters and arrives at the base body to be reflected, and is further reflected on the surface toward the inside of the film to be absorbed, or an effect of interference with a beam that has further passed through multi-reflection paths appear depending on the optical path difference of these beams. Further, a covering layer of the organic photoreceptor is formed by the method of solution coating such as immersion coating which tends to cause layer thickness unevenness, and this layer thickness unevenness tends to increase the interference effect. Namely, if there is a layer thickness unevenness that is in the same level as that of a wavelength of light for image-wise exposure, the interference effect is increased by a difference in an optical path length caused by the layer thickness unevenness, and image density unevenness which is a so-called moiré fringe appears on the image.

A theoretical method considered to reduce the moiré fringes is to prevent reflected light almost perfectly, or to reduce the layer thickness unevenness to the level at which the interference is not generated. Practically, however, it is difficult to prevent thoroughly reflected light coming from the conductive base body, especially in the case of an organic photoreceptor, and in the separated-function type photoreceptor wherein translucent CTL is provided on the upper layer, and CGL is installed to be close to the conductive base body, its interference effect extremely tends to appear.

In the method to form a layer on an organic photoreceptor, a coating solution is prepared and is coated, then, it is dried. In that case, it is substantially impossible to control layer thickness unevenness on the level of the wavelength, because a phenomenon of air convection is generated.

Therefore, if gradation reproducibility is improved for improving image quality in particular, it is extremely difficult to control occurrence of moiré fringes of this kind. For these problems, there have been tried methods to prevent reflection on the base body and to reduce layer thickness unevenness, however, none of these methods obtained sufficient effect.

Further, in recent years, it was found that the use of polymerization toner is effective for improving image quality, and it has become possible to obtain the unprecedented high resolution and gradation reproducibility by using the polymerization toner. In the polymerization toner, it is easy to obtain the monodispersed state wherein particle sizes are all alike even if the particle size is as small as 3-7 μm, which makes an effect of image quality improvement to be natural. However, on the image quality with high resolution resulting from the use of the polymerization toner, the aforementioned moir\acute{e} fringes tend to be conspicuous.

Further, energy of contact between the organic photoreceptor and toner that visualized an electrostatic latent image formed on the photoreceptor is great, and therefore, various problems tend to be caused in cleaning of residual toner remaining on the photoreceptor after the toner image is transferred onto the transfer material in the transfer step. In particular, the polymerization toner tends to be manufactured to be substantially in a shape of a sphere because a toner shape is formed in the course of polymerization of monomer, thus, insufficient cleaning tends to be caused. The insufficient cleaning is related to layer thickness unevenness of the organic photoreceptor, and there is observed a trend that insufficient cleaning tends to be caused for the photoreceptor on which the layer thickness unevenness is great.

The invention has been achieved in view of the related art stated above, and an object of the invention on one aspect is to provide an organic photoreceptor wherein gradation reproducibility is high and moiré fringes are not conspicuous, and to provide an image forming method and an image forming apparatus wherein moiré fringes are not conspicuous when an organic photoreceptor and a polymerization toner are used, cleaning property for toner is excellent for a long time, and a sharp electrophotographic image can be formed.

### SUMMARY

The first aspect is an organic photoconductor that is equipped with a covering layer on a base body, wherein a layer thickness deviation of a substantial-image forming area of the covering layer is 0.2-2.0 pm, and there is relationship of following expression 1 between mean value PWS of reflected light amount power spectrum in the range of spatial frequency 0-2 mm⁻¹ measured with exposure wavelength λm of image-wise exposure light and mean value P of an amount of reflected light.
0<(PWS/P²)<5.0×10⁻⁴ mm⁻¹ Expression 1

The second aspect is the image forming apparatus having the organic photoreceptor described in the first aspect.

The third aspect is an image forming method employing the organic photoreceptor described in the first aspect.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a diagram showing an example of schematic structure of immersion coating apparatus for one by one drum that makes a layer thickness deviation of the covering layer to be less.

In FIG. 2, (a) is an illustration showing a projected image of a toner particle having no corner, and each of (b) and (c) is an illustration showing a projected image of a toner particle having a corner.

FIG. 3 is a schematic structure diagram showing an example of the total structure of an image forming apparatus.

### DETAILED DESCRIPTION OF EXEMPLARY EMBODIMENTS

The invention will be explained as follows.

After the repeated examinations, the inventors of the invention found out that it is effective to lessen a layer thickness deviation of a covering layer of the organic photoreceptor and to lessen reflected light amount power spectrum of low frequency spatial frequency for preventing occurrence of moiré fringes and occurrence of insufficient cleaning which tend to take place when forming digital electrophotographic images having excellent sharpness by using toner having relatively uniform particle size distribution such as polymerization toner.

The main structure of the photoreceptor is as follows.

The first aspect is an organic photoreceptor wherein a layer thickness deviation of the substantial image forming area of the covering layer is 0.2-2.0 μm in the organic photoreceptor that is provided on its base body with a covering layer, and there is relationship of the following expression 1 between mean value PWS of reflected light amount power spectrum in the range of spatial frequency 0-2 mm⁻¹ measured with exposure wavelength 680 nm and mean value P of reflected light amount.
0<(PWS/P²)<5.0×10⁻⁴ mm⁻¹ Expression 1

The inventors of the invention further found out that the organic photoconductor of that kind is especially effective when forming the electrophotographic images having high image quality by using toner wherein a form factor of polymerization toner and particle size distribution are relatively uniform.

Namely, in the image forming method wherein an electrostatic latent image is formed on the foregoing photoreceptor, the electrostatic latent image is changed by a developing means to a toner image, the toner image is transferred onto a transfer material, and then, a cleaning means provided in the image forming method removes toner remaining on the organic photoreceptor, it is useful that the toner used in the developing means satisfies at least one of the following characteristics (1)-(5).
(1) The toner wherein a coefficient of variation of a shape coefficient of the toner is not more than 16%, and a coefficient of variation of the number in the particle size distribution in terms of the number for the toner particles is not more than 27%
(2) The toner that contains 65% or more in terms of the number of the toner particles whose shape coefficient is in the range of 1.2-1.6
(3) The toner that contains 50% or more in terms of the number of the toner particles each having no corner
(4) The toner wherein, in the histogram showing the particle size distribution of the number standard in which the horizontal axis representing a natural logarithm InD where D (μm) represents a particle diameter of the toner particle is classified into plural classes at intervals of 0.23, the sum (M) of the relative frequency (m₁) of toner particles included in the most frequent-class and the relative frequency (m₂) of toner particles included in the second most frequent class to the most frequent class is 70% or more
(5) The toner wherein the ratio (Dv50 /Dp50) of the 50% volume particle diameter (Dv50) to the 50% number particle diameter (Dp50) is 1.0-1.15, the ratio (Dv75/Dp75) of the accumulation 75% volume particle diameter (Dv75) from the greatest volume particle diameter of the toner to the accumulation 75% number particle diameter (Dp75) from the greatest number particle diameter of the toner is 1.0-1.20, and the number of toner particles in which the particle diameter is not more than 0.7×(Dp50) is 10 number % or less in the total toner particles.

Details will be explained as follows.

The organic photoreceptor is represented by one equipped with a covering layer having on its base body an organic light sensitive layer, wherein layer thickness deviation in the circumferential direction of the photoreceptor of the covering layer capable of forming images substantially of the organic photoreceptor is 0.2-2.0 μm, and layer thickness deviation in the optical axis direction is 0.2-2.0 μm, and there is a relationship of the following expression 1 between mean value PWS of reflected light amount power spectrum in the range of spatial frequency 0-2 mm⁻¹ measured with exposure wavelength 680 nm and mean value P of the reflected light amount.
0<(PWS/P²)<5.0×10⁻⁴ mm⁻¹ Expression 1

Namely, although layer thickness deviations in the circumferential direction of the photoreceptor covering layer and in the axial direction are varied within a range of 0.2-2.0 μm, an occurrence of moiré fringes on the organic photoreceptor satisfying the foregoing Expression 1 are remarkably improved, cleaning properties are improved because of excellent uniformity of covering layer thickness, moiré fringes are not conspicuous even when using the toner with uniform form manufactured by a polymerization method, and insufficient cleaning caused by slipping off of toner is not caused, which makes it possible to obtain sharp and excellent electrophotographic images.

As a method to make the foregoing mean value, PWS of reflected light amount power spectrum to be small, it is preferable to add substances to scatter image-wise exposure light into the covering layer of the photoreceptor, and thereby, to make the reflected light amount of the image-wise exposure light to be small. Namely, the organic photoreceptor has usually an intermediate layer, a light sensitive layer such as a charge generation layer and a charge transport layer, or a protective layer as occasion demands, on a conductive support, and it is preferable to add in the intermediate layer or in the light sensitive layer the substances which scatter image-wise exposure light. It is also effective to scatter image-wise exposure light by roughening the surface of the base body.

The most preferable method to scatter the image-wise exposure light is to make the intermediate layer between the cylindrical base body and the light sensitive layer to contain inorganic particles whose number average first order particle diameter is in a range of 0.02-0.5 μm which do not deteriorate electrophotographic characteristics. As examples of these, fine grains of metal oxide particles, copper sulfate, zinc sulfate and titanium oxide can be used. In particular, the titanium oxide is preferable because its fine grains with various crystal forms, particle diameters and various surface treatment conditions can be used through selection depending on purposes. Further, it is preferable to use these inorganic particles in the intermediate layer, for holding the effect to improve blocking characteristics to prevent electron injection from the support to the intermediate layer. It is preferable that content of the metal oxide in the intermediate layer is 3-50% of the total mass of the intermediate layer, and as a layer thickness of the intermediate layer, a range of 0.5-20 μm is preferable.

On the other hand, when light scattering substances are not contained in the intermediate layer or in the light sensitive layer, the foregoing value of (PWS/P²) tends to be greater than 5.0×10⁻⁴ mm⁻¹, and when its value becomes greater, there is a possibility that moiré fringes are caused, even when the layer thickness deviation of the covering layer of the photoreceptor is small. Moiré fringes are easily caused especially on gray scale images. It is preferable that the value of (PWS/P²) is smaller than 1.0×10⁻⁴ mm⁻¹.

Next, it is preferable that the covering layer of the photoreceptor is manufactured to be within a range of 0.2-2.0 μm in terms of the layer thickness deviation in the circumferential direction and in the axial direction of the photoreceptor. Since the organic photoreceptor is usually manufactured by coating a coating solution of a light sensitive layer on a conductive base body, it is difficult to manufacture so that the layer structure deviation of the covering layer may be smaller than 0.2 μm. On the other hand, when the layer thickness deviation in the circumferential direction and in the axial direction of the photoreceptor is greater than 2.0 μm, moiré fringes are easily caused even when the value of the (PWS/P²) is smaller than 5.0×10⁻⁴ mm⁻¹, and insufficient cleaning caused by slipping off of toner tends to be caused, because irregularities on the surface of the photoreceptor becomes greater. The layer thickness deviation of the photoreceptor and a measurement method of the value (PWS/P²) will be explained.

Measuring Method for Layer Thickness Deviation

An image forming area of the covering layer where an image can be formed substantially is an area where, when an image is formed by an image forming apparatus of an electrophotographic system, a photoreceptor is exposed to light by the foregoing apparatus, then, toner is supplied to the photoreceptor thus exposed to light from the developing section, and a latent image on the photoreceptor is developed, and it is an area that is actually used by the image forming apparatus for image forming. A specific image-wise exposure area can be stipulated by the width of the photoreceptor in the axial direction.

In the actual measuring method for the layer thickness deviation, an image area of an organic photoreceptor is measured at intervals of 10 mm in the axial direction and at intervals of 10 mm in the circumferential direction on the center of rotation direction, and a difference between the maximum value and the minimum value among all measurement values is designated as the layer thickness deviation of the covering layer of the invention. The axial direction in this case means a direction of a length of a center axis for rotation in the case of cylindrical form, and the circumferential direction on the center of rotation direction means a direction of rotation along a circumference from a start point which is determined at the center in the axial direction of the image forming area of the photoreceptor. In the case of a belt form, the axial direction means an axial direction of a supporting member for rotating a belt, and the circumferential direction on the center of rotation direction means a direction of rotation along a circumference from a start point which is determined at the center in the axial direction of the image forming area of the photoreceptor.

For measuring the layer thickness deviation, a layer thickness meter of an eddy current type Fischerscope (made by Fischer Co.) is used as a layer thickness measuring instrument. However, if there are available layer thickness measuring instruments each having the same measurement accuracy as in the foregoing measuring instrument, any instrument can be used.

Measuring Method for (PWS/P²) Value

For the power spectrum, a laser displacement meter LC2400 made by Keyence Corporation is installed at the position of a regular reflection in the axial direction of the photoreceptor, then, its amount of reflected light is measured at 243 points, and an irregular change measured value of an amount of reflected light thus measured is obtained by using a Fourier-transformed value. The regular reflection in this case means a reflection wherein an angle formed by the axial direction and an incident light is substantially the same as that formed by the axial direction and a reflected light.

The foregoing 243 measuring points for an amount of reflected light includes 81 points where the central portion 40 mm (±20 mm from the central point in the axial direction of the photoreceptor) in the axial direction of the photoreceptor is measured (up to the measurement area 0.0-40 mm) at intervals of 0.5 mm, 81 points where measurement was conducted in the same way by shifting the position in the circumferential direction by +0.1 mm and 81 points where measurement was made in the same way by shifting the position in the circumferential direction by −0.1 mm.

When an amount of reflected light at each measuring point is represented by Pᵢⱼ (i represents integers from 1 to 3, and j represents integers from 0 to 80), mean value P of the amount of reflected light is as follows.

$$P = \frac{1}{3 \times 81} {\sum }_{i = 1}^{3} {\sum }_{j = 0}^{80} {P}_{ij} \qquad ( Numeral 1 )$$

Next, the function (the function obtained as composition of sine waves of frequencies each having different phase and amplitude) of 81 irregular change measured values measured at the foregoing 81 points is subjected to Fourier transform. As the Fourier transform, it was carried out by using the discrete Fourier transform expression shown below.

$${F}_{n}^{i} = \frac{1}{L} {\sum }_{j = 0}^{80} Δ {P}_{ij} sin ( \frac{π \cdot Δ X \cdot {X}_{j}}{L} \cdot n ) \qquad ( Numeral 2 )$$

In the expression above, L represents measurement area distance: 40.0 mm, Δ× represents measurement distance: 0.5 mm, xⱼ represents an order of measurement points: integers from 0 (start)-80 (end), n represents integers 0-80 and ΔPᵢⱼ represents a difference between an amount of reflected light and a mean value of amounts of reflected light at each measuring point expressed by the following expression.
ΔPᵢⱼ=Pᵢⱼ−P (Numeral 3)

Further, in the foregoing measurement conditions, a spatial frequency is expressed by (n/40 mm⁻¹).

Mean value PWS of reflected light amount power spectrum in the range (n is 0-80) of spatial frequency is obtained from the following expression by using function Fⁱₙ obtained above.

$$PWS = \frac{1}{3} {\sum }_{i = 1}^{3} {\vert {F}_{n} \vert}^{2} \qquad ( Numeral 4 )$$

Incidentally, conditions for measurement of an amount of reflected light were as follows. Laser displacement meter LC2400 (laser wavelength: 680 nm) made by Keyence Corporation was adjusted so that a distance between a tip of the sensor and a surface of the photoreceptor may be within 10 mm ±10 μm, then, a laser beam was irradiated from the direction of a regular reflection (45°) along the axial direction of the photoreceptor, and its reflected light amount was measured at each measuring point in the same way as in the PWS stated above to obtain its mean value.

When measuring the spatial frequency, a light source with a wavelength of 680 nm is actually used, though the wavelength of the actual exposure light should be used for measurement, properly speaking. Since this wavelength area is relatively close to the exposure light wavelength of the exposure light source in the case of using laser (LD) or a light emitting diode (LED) used generally for latent image formation of digital images, the light source having the aforesaid wavelength area is used. However, even in the case where image formation is conducted by the image forming apparatus in the wavelength area other than this light source, its effect can be estimated by the occasion wherein measurement is conducted with the light source having a wavelength of 680 nm. The reason for the foregoing is that various problems can be prevented even in the other wavelength area, because various problems (moiré fringes in particular) can be prevented in the aforesaid light source under the condition that phases of light components are made uniform in particular and interference fringes (moiré) tend to be caused in the aforesaid wavelength.

Next, the layer structure of the organic photoreceptor and the coating method of the organic photoreceptor are described below in which the deviation of the layer thickness in the circumference direction and in the axis direction is within the range of from 0.2 to 2.0 μm.

The organic photoreceptor is an electrophotographic photoreceptor in which one of the charge generation function and the charge transfer function essential for constituting the electrophotographic photoreceptor is charged with an organic compound, which entirely includes photoreceptors such as those constituted by a known charge generation material or a known charge transfer material and those in which the charge generation function and the charge transfer function are also charged on a high molecular weight complex.

Though there is no limitation on the layer constitution of the photoreceptor, a constitution in which an intermediate layer, a charge generation layer and a charge transfer layer are provided on an electroconductive substrate, and that in which a charge generation-transfer layer (a layer having both of the charge generation function and the charge transfer function) is provided on the electroconductive substrate, and that in which a protective layer is further provided on the above layers have been well known. Though the resin layer may be applied to any of the above-described layers, it is preferred that the resin layer according to the invention is applied to the protective layer constituting the surface layer.

Electroconductive Substrate

The electroconductive substrate may be either a cylindrical substrate or an endless belt substrate. The cylindrical one is particularly preferred.

The cylindrical substrate is a cylindrical support necessary for endlessly forming images by rotation thereof, and an electroconductive substrate having a circular degree of not more than 0.1 mm and a swinging of not more than 0.1 mm is preferable. When the circular degree and the swinging exceed the above range, the suitable image formation is become difficult.

As the electroconductive material, a metal drum of aluminum or nickel, a plastic drum deposited with aluminum, tin oxide or indium oxide, and a paper-plastic drum coated with an electroconductive substance are employable. The specific electric resistance of the electroconductive substrate is preferably not more than 10³ Ωcm.

Intermediate Layer

In the organic photoreceptor, the intermediate layer provided between the substrate and the photosensitive layer may contain an inorganic particle having a number average diameter of primary particles of from 0.02 to 0.5 μm. The number average diameter of primary particles can be determined by enlarging by 10,000 times with a transmission electron micrometer and calculating the average diameter in the Fere direction of randomly selected 100 primary particles by image analysis.

The inorganic particles may be metal oxide, particularly a metal oxide particle such as titanium oxide (TiO₂), zinc oxide (ZnO₂) and tin oxide (SnO₂); and copper sulfate and zinc sulfate are usable. Among the above, titanium oxide is preferable and titanium oxide treated on the particle surface for improving the dispersibility thereof is particularly preferable.

The surface of the titanium oxide particle is preferably covered with metal oxide, a reactive organic silicon compound or an organic metal compound. Examples of the titanium oxide particle are described below.

One of preferable surface treatments of the titanium oxide particle is a treatment in which plural times of treatment are provided on the surface and the last treatment is carried out by the reactive organic silicon compound.

Another preferable surface treatment of the titanium oxide particle is that by methylhydrogenpolysiloxane.

Another preferable surface treatment of the titanium oxide particle is that by an organic silicon compound having a fluorine atom. In this case, the treatment may be either performed by plural times or performed at the last of the plural times of the treatment.

The degradation in the electrophotographic properties such as the remaining potential and the charging potential can be inhibited, the occurrence of black spots can be considerably reduced and the occurrence of moiré by the laser exposure can be improved by the provision of the intermediate layer containing the above surface treated titanium oxide particles between the substrate and the photosensitive layer.

The number average diameter of primary particles of the above titanium oxide particle is preferably within the range of from 0.02 to 0.5 μm. The titanium oxide particles having the number average diameter of primary particles within the above range show high dispersing stability in the intermediate layer and lower the power spectrum in the range of the space frequency of from 0 to 2 mm⁻¹ so that the occurrence of moiré can be prevent. When the average particle diameter is lower than 0.02 μm, the lowering of the power spectrum within the above-mentioned range is insufficient and the effect for preventing the occurrence of moiré is small. On the other hand, the black spots specifically occurring in the reversal development tend to occur when the average diameter is larger than 0.5 μm.

Though the shape of titanium oxide particles includes a dendrite shape, a needle-like shape and granule shape and the crystal type of that includes anatase type, rutile type and amorphous, one having any shape and any crystal type may by employed. A mixture of two or more kinds different from each other in the shape or the crystal type may be employed.

In one of the surface treatments for the titanium oxide particle, the particle is preferably subjected to plural times of the treatment, and the last treatment in the plural times of the treatment is preferably performed with the reactive organic silicon compound. It is preferable that at least one of the plural times of the treatment is performed by the use of one or more compounds selected from alumina (Al₂O₃), silica (SiO₂) and zirconia (ZrO₂), and the treatment with the reactive organic silicon compound is applied at last. The above compounds may be a hydrate thereof.

It is another preferable treatment to be applied to the titanium oxide particle that the plural times of treatment are applied and the last treatment is carried out with a reactive organic titanium compound or a reactive organic zirconium compound. It is preferable that at least one of the plural times of the surface treatments is carried out by the use of at least one selected from alumina, silica and zirconia and the last treatment is carried out with the reactive organic titanium compound or the reactive organic zirconium compound.

The surface of the titanium oxide particle can be uniformly covered by two or more times of the treatments. The titanium oxide particles can be suitably dispersed in the intermediate layer and the good photoreceptor not causing image defect such as the black spots can be obtained by the use of such the treated titanium oxide particles in the intermediate layer.

A surface treatment in which the plural times of the surface treatments are carried out by the use of alumina or silica and then treated with the reactive organic silicon compound is applied, and a treatment in which the plural times of the surface treatments are carried out by the use of alumina or silica and then treated with the reactive organic titanium compound or the reactive organic zirconium compound is applied, are particularly preferred.

Though the treatment with alumina and that with silica may be simultaneously applied, it is preferable that the treatment with alumina is firstly carried out and then the treatment with silica is applied. When the treatment with alumina and that with silica are applied, it is preferable that the amount of the silica is larger than that of the alumina.

The surface treatment of the titanium oxide particles with alumina, silica or zirconia can be performed by a wetting method. For example, the titanium oxide particles treated with silica or alumina can be produced as follows.

Titanium oxide particles having a number average diameter of premier particles of 300 nm is dispersed in water in a concentration of 50 to 350 g/l for preparing aqueous slurry, and water-soluble silicate or a water-soluble aluminum compound is added to the slurry. And then the slurry is neutralized by adding an alkali or an acid for precipitating silica or alumina onto the surface of the titanium oxide particles. Thereafter, the titanium oxide particles is filtered, washed and dried to obtain the objective surface treated titanium oxide particles. When sodium silicate is employed as the water-soluble silicate, the neutralization can be carried out by means of an acid such as sulfuric acid, nitric acid and hydrochloric acid. When aluminum sulfate is used as the water-soluble aluminum compound, the neutralization can be carried out by means of an alkali such as sodium hydroxide and potassium hydroxide.

The amount of the metal oxide to be employed for the above surface treatment is preferably from 0.1 to 50, and more preferably from 1 to 10, parts by weight to 100 parts by weight of an N-type semiconductor particle such as the titanium oxide particle in the charged amount for the surface treatment. For example, in the case of the titanium oxide, when alumina and silica above-described are used, from 0.1 to 50 parts by weight of each of the alumina and silica are preferably employed to 100 parts by weight of the titanium oxide particles, and the amount of the silica is larger than that of the alumina.

The surface treatment with the reactive organic silicon compound following the surface treatment with the metal oxide is preferably carried out by the wet method described below.

The titanium oxide particles treated with the metal oxide are added to a solution or suspension of the reactive organic silicon compound in an organic solvent or water and the liquid is stirred for a period of from several minutes to about 1 hour. The resultant liquid is subjected to a heat treatment in some cases. Thereafter, the particles are filtered and dried to obtain the titanium oxide particles covered on the surface with the organic silicon compound. It is allowed to add the reactive organic silicon compound to a suspension of the titanium oxide in the organic solvent or water.

The fact that the surface of the titanium oxide particle is covered with the reactive organic silicon compound can be confirmed by a combination of surface analysis methods such as electron spectroscopy for chemical analysis, Auger electron spectroscopy, secondary mass spectroscopy and diffusion reflectance FI-IR.

The amount of the reactive organic silicon compound to be employed for the surface treatment is preferably from 0.1 to 50, and more preferably from 1 to 10, parts by weight to 100 parts by weight of the titanium oxide treated with the metal oxide in the charged amount on the occasion of the surface treatment. When the amount of the compound for the surface treatment is less than the above range, the effect of the surface treatment is become insufficient and the dispersing ability of the titanium oxide particles in the intermediate layer is degraded. When the amount exceeds the above range, the electric properties are degraded so that the increasing in the remaining potential and the lowering of the charging potential are resulted.

The reactive organic silicon compound is a compound capable of condensation reacting with a hydroxyl group on the surface of the titanium oxide. Preferable examples of the compound are represented by the following Formula 1.
(R)ₙ—Si—(X)₄₋ₙ Formula 1

In the above, Si is a silicon atom, R is an organic group which is directly bonded to the silicon atom by the carbon atom thereof, X is a hydrolysable group and n is an integer of from 0 to 3.

Examples of the organic group represented by R which is directly bonded to the silicon atom by the carbon atom thereof include an alkyl group such as a methyl group, an ethyl group, a propyl group, a butyl group, a pentyl group, a hexyl group, an octyl group and a dodecyl group; an aryl group such as a phenyl group, a tolyl group, a naphthyl group and a biphenyl group; an epoxy group-containing group such as a γ-glycidoxypropyl group and a β-(3,4-epoxycyclohexyl)ethyl group; a (metha)acryloyl group-containing group such as a γ-acryloxypropyl group and a γ-methacryloxypropyl group; a hydroxyl group-containing group such as a γ-hydroxy propyl group and a 2,3-dihydroxypropyloxypropyl group; a vinyl group-containing group such as a vinyl group and a propenyl group; a mercapto group-containing group such as a γ-mercaptopropyl group; an amino group-containing group such as a γ-aminopropyl group and an N-β(aminoethyl)-γ-aminopropyl group; a halogen-containing group such as a γ-chloropropyl group, 1,1,1-trifluoropropyl group, a nonafluorohexyl group and a perfluorooctylethyl group; and an alkyl group substituted. by a nitro group or a cyano group. Examples of the hydrolysable group represented by X include an alkoxyl group such as a methoxy group and an ethoxy group; a halogen atom and an acyloxy group.

The organic silicon compounds represented by Formula 1 may be used singly or in combination.

In the compound represented by Formula 1, when n is 2 or ±s s plural groups represented by R may be the same or different from each other when n is 2 or more, and groups represented by X may be the same or different from each other. When two or more kinds of the compound are used, R and X may be the same or different from each other between the different compounds.

Examples of the compound in which n is 0 are as. follows: tetrachlorosilane, diethoxydichlorosilane,. tetramethoxy-silane, phenoxytrichlorosilane, tetraacetoxysilame, tetraethoxysilane, tetraallyoxysilane, tetrapropoxysilane, tetrakis(2-methoxyethoxy)silane, tetrabutoxysilane, tetraphenoxysilane, tetrakis (2-ethylbutoxy)silane and tetrakis(2-ethylhexyloxy)silane.

Examples of the compound in which n is 1 are as follows: trichlorosilane, methyltrichlorosilane, vinyltrichloro-silane, ethyltrichlorosilane, allyltrichlorosilane, n-propyltrichlorosilane, n-butyltrichlorosilane, chloromethylmethotrimethoxysilane, mercaptomethyl-trimethoxysilane, trimethoxyvinylsilane, ethyltrimethoxy-silane, 3,3,4,4,5,5,6,6,6-nonafluorohexyltrichlorosilane, phenyltrichlorosilane, 3,3,3-trifluoropropyl-trimethoxysilane, 3-chloropropyltrimethoxysilane, triethoxysilane, 3-mercaptopropyltrimethoxysilane, 3-aminopropyltrimethoxysilane, 2-aminoethylaminometyl-trimethoxysilane, benzyltrichlorosilane, methyltriacetoxysilane, chloromethyltriethoxysilane, ethyltriacetoxysilane, phenyltrimethoxysilane, 3-allylthiopropyltrimethoxysilane, 3-glycidoxypropyl-trimethoxysilane, 3-bromopropyltriethoxysilane, 3-allyaminopropyltrimethoxysilane, propyltriethoxysilane, hexyltritrimethoxysilane, 3-aminopropyltriethoxysilane, 3-methacryloxypropyltrimethoxysilane, bis(ethylmethylketoxime)methoxymethylsilane, octyltriethoxysilane and dodecyltriethoxysilane.

Examples of the compound in which n is 2 are as follows: dimethyldichlorosilane, dimethoxymethylsilane, dimethoxydimethylsilane, methyl-3,3,3-trifluoropropyl-dichlorosilane, diethoxysilane, diethoxymethylsilane, dimethoxymethyl-3,3,3-trifluoropropylsilane, chloromethyldiethoxysilane, diethoxydimethylsilane, dimethoxy-3-mercaptopropylmethylsilane, 3,3,4,4,5,5,6,6,6-nonafluorohexylmethyldichlorosilane, diacetoxymethylvinylsilane, diethoxymethylvinylsilane, 3-methacryloxypropylmethyldichlorosoilane,3-(2-aminoethyl-aminopropyl)dimethoxymethylsilane, t-butylphenyldichloro-silane, 3-methacryloxypropyldimethoxymethylsilane, 3-(2-acetoxyethylthiopropyl)dimethoxymethylsilane, dimethoxymethyl-2-piperidinoethylsilane, dibutoxydimethylsilane, 3-dimethylaminopropyl-diethoxymethylsilane, diethoxymethylphenylsilane, diethoxy-3-glycidoxypropylmethylsilane, 3-(3-acetoxyporopylthio)propyldimethoxymethylsilane, dimethoxymethyl-3-piperidinopropylsilane and diethoxymethyloctadecylsilane.

Examples of the compound in which n is 3 are as follows: trimethylchlorosilane, methoxytrimethylsilane, ethoxytrimethylsilane, methoxydimethyl-3,3,3-trifluoropropylsilane, 3-chloropropylmethoxydimethylsilane and methoxy-3-mercaptopropylmethylmethylsilane.

Preferable examples of the organic silicon compound represented by Formula 2 are represented by the following Formula 1.
R—Si—(X)₃ Formula 2

In the above, R is an alkyl group or an aryl group; and X is a methoxy group, an ethoxy group or a halogen atom.

R is preferably an alkyl group having from 4 to 8 carbon atoms. Examples of the preferable compound include trimethoxy-n-butylsilane, trimethoxy-i-butylsilane, trimethoxyhexylsilane and trimethoxyoctylsilane.

A hydrogenpolysiloxane compound is preferably used as the reactive organic silicon compound to be used in the last surface treatment. The hydrogenpolysiloxane having a molecular weight of from 1,000 to 20,000 is easily available and shows a suitable black spot inhibiting ability.

Particularly, good effect can be obtained when methylhydrogenpolysiloxane is used for the last surface treatment.

Another surface treatment for the titanium oxide is a treatment by an organic silicon compound having a fluorine atom. The treatment using the organic silicon compound having a fluorine atom is preferably applied by the following wet method.

The organic silicon compound having a fluorine atom is dissolved or suspended in an organic solvent or water and untreated titanium oxide particles are added therein. The liquid is mixed by stirring for a period of from several minutes to about 1 hour. Then the particles are filtered and dried. Thus the surface of each of the titanium oxide particles is covered by the organic silicon compound having a fluorine atom. In some cases, the mixture is heated before the filtration. The organic silicon compound having a fluorine atom may be added to the suspension comprising the organic solvent or water and the titanium oxide particles dispersed therein.

It is confirmed by a combination of surface analysis means such as electron spectroscopy for chemical analysis (ESCA), Auger electron spectroscopy, secondary ion mass spectroscopy and scatter reflection FI-IR that the surface of the titanium oxide particle is covered with the organic silicon compound having a fluorine atom.

Examples of the organic silicon compound having a fluorine atom include 3,3,4,4,5,5,6,6,6-nonafluoro-hexyltrichlorosilane, 3,3,3-trifluoropropyltrimethoxysilane, methyl-3,3,3-trifluoropropyldichlorosilane, dimethoxymethyl-3,3,3-trifluoropropylsilane and 3,3,4,4,5,5,6,6,6-nonafluorohexylmethyldichlorosilane.

The interlayer is formed by coating a liquid comprising a solvent in which the surface-treated N-type semiconductive particles such as the surface-treated titanium oxide particles are dispersed together with a binder resin, on an electroconductive substrate.

The interlayer is provided between the electroconductive substrate and the photosensitive layer and has functions of suitably adhering with the electroconductive substrate and the photosensitive layer, suitably transfer an electron injected from the photosensitive layer to the electroconductive substrate and preventing the positive hole injection from the substrate as a barrier.

The resin binder usable in the interlayer includes a polyamide resin, a vinyl chloride resin, a vinyl acetate resin, a poly(vinyl acetal) resin, a poly(vinyl butyral) resin, a polyvinyl alcohol, a thermal hardenable resin such as a melamine resin, an epoxy resin and an alkyd resin, and a copolymer resin composed of two or more repeating units of the fore going resins. Among them, the polyamide resin is preferable and an alcohol-soluble polyamide such as an amide copolymer and a methoxymethylolized amide polymer is particularly preferable. The amount of the surface-treated N-type semiconductive particle according to the invention to be dispersed in the binder is from 10 to 10,000 parts, preferably from 50 to 1,000 parts, by weight per 100 parts by weight of the binder resin in the case of the surface-treated titanium oxide. When the surface-treated titanium oxide is used in the foregoing amount, the dispersed status of the titanium oxide can be suitably maintained and a suitable interlayer without the formation of black spot can be formed.

The thickness of the interlayer is preferably from 0.5 to 15 μm for forming the interlayer having a suitable electrophotographic property without the formation of black spot.

The preferable compositions of the photosensitive layer to be used in the electrographic photoreceptor according to the invention is described below.

Photosensitive Layer

It is preferable that the photosensitive layer having a charge generation layer CGL and a charge transfer layer CTL separated from each other even though a single structure photosensitive layer having both of the charge generation function and the charge transfer function may be used. The increasing of the remaining potential accompanied with repetition of the use can be inhibited and another electrophotographic property can be suitably controlled by the separation the functions of the photosensitive layer into the charge generation and the charge transfer. In the photoreceptor to be negatively charged, it is preferable that the CGL is provided on a subbing layer and the CTL is further provided on the CGL. In the photoreceptor to be positively charged, the order of the CGL and CTL in the negatively charged photoreceptor is revered. The foregoing photoreceptor to be negatively charged having the function separated structure is most preferable.

The photosensitive layer of the function separated negatively charged photoreceptor is described below.

Charge Generation Layer

Charge generation layer: the charge generation layer contains one or more kinds of charge generation material CGM. Another material such as a binder resin and additive may be contains according to necessity.

Examples of usable CGM include a phthalocyanine pigment, an azo pigment, a perylene pigment and an azulenium pigment. Among them, the CGM having a steric and potential structure capable of taking a stable intermolecular aggregated structure can strongly inhibit the increasing of the remaining potential accompanied with the repetition of use. Concrete examples of such the CGM include a phthalocyanine pigment and a perylene pigment each having a specific crystal structure. For example, a titanylphthalocyanine having the maximum peak of Bragg angle 2 θ of Cu—Kα ray at 27.2° and a benzimidazoleperylene having the maximum peak of Bragg angle 2 θ of Cu—Kα ray at 12.4° as the CGM are almost not deteriorated by the repetition of use and the increasing of the remaining potential is small.

A binder can be used in the charge generation layer as the dispersion medium of the CGM. Examples of the most preferable resin include a formal resin, a silicone resin, a silicon-modified butyral resin and a phenoxy resin. The ratio of the binder resin to the charge generation material is from 20 to 600 parts by weight to 100 parts by weight of the binder resin. By the use of such the resin, the increasing of the remaining potential accompanied with the repetition of use can be minimized. The thickness of the charge generation layer is preferably from 0.01 μm to 2 μm.

Charge Transfer Layer

Charge transfer layer: the charge transfer layer contains a charge transfer material CTM and a layer-formable. binder resin in which the CTM is dispersed. An additive such as an antioxidant may be further contained according to necessity.

Known compounds such as, a triphenylamine derivative, a hydrazone compound, a styryl compound, a benzyl compound and a butadiene compound may be used as the charge transfer material CTM. These charge transfer material are usually dissolved in a suitable binder resin to form a layer. Among them, the charge transfer materials capable of minimizing the increasing of the remaining potential accompanied with repetition of use is one having a high electron mobility of not less than 10⁻⁵ cm²/V·sec, and the difference of the ionization potential of such the CTM and that of the CGM to be used in combination with the CTM is preferably not more than 0.5 (eV), more preferably not more than 0.25 (eV).

The ionization potential of the CGM and CTM is measured by a surface analyzer AC-1, manufactured by Riken Keiki Co., Ltd.

Examples of the resin to be used for charge transfer layer CTL include a polystyrene, an acryl resin, a methacryl resin, a vinyl chloride resin, a vinyl acetate resin, a poly(vinyl butyral) resin, an epoxy resin, a polyurethane resin, a phenol resin, a polyester resin, an alkyd resin, a polycarbonate resin, a silicone resin, a melamine resin, a copolymer containing two or more kinds of the repeating unit contained the foregoing resins, and a high molecular weight organic semiconductive material such as poly (N-vinylcarbazole) other than the foregoing insulating resins.

The polycarbonate resin is most preferable as the binder for CTL. The polycarbonate resin is most preferable since the resin simultaneously improves the anti-abrasion ability, the dispersing ability of the CTM and the electrophotographic property of the photoreceptor. The ratio of the binder resin to the charge transfer material is preferably from 10 to 200 parts by weight to 100 parts by weight of the binder resin, and-the thickness of the charge transfer layer is preferably from 10 to 40 μm.

When manufacturing covering layers such as an intermediate layer, a charge generation layer and a charge transport layer so that a layer thickness deviation of the total layer thickness thereof may be within a range of 0.2-2.0 μm in the axial direction and in the circumferential direction of the cylindrical base body, they need to be manufactured under the condition wherein coated layer thickness of the covering layer is made to be uniform in the coating process and in the drying process. An example of an immersion coating apparatus for an organic photoreceptor capable of making a uniform layer thickness will be described below.

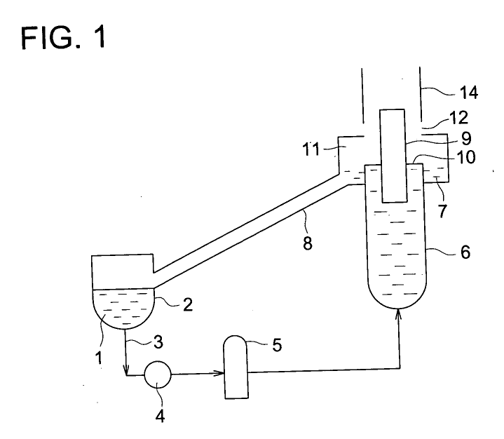

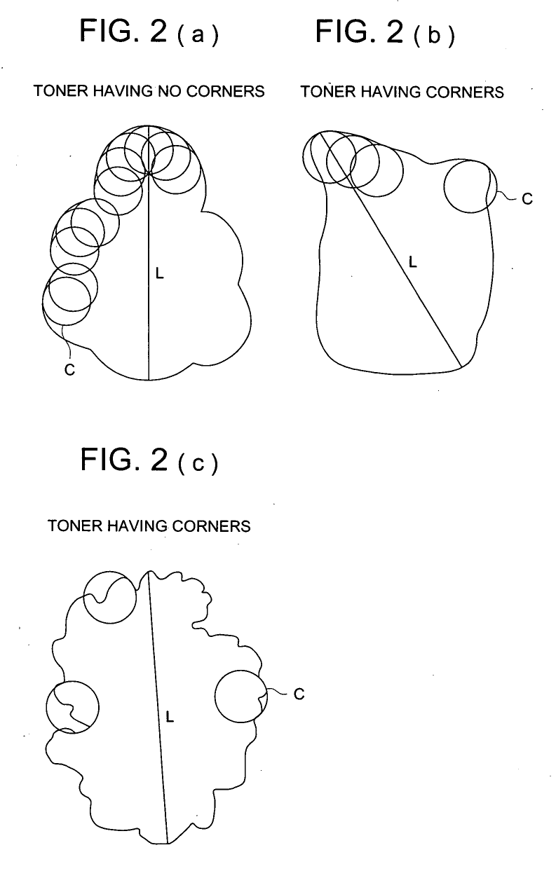

FIG. 1 is a diagram showing the schematic structure of an example of an immersion coating apparatus for one drum by one drum that makes a layer thickness deviation of the covering layer to be less, and cylindrical conductive base body 9 is on the half way of pulling up from a coating tank, after being subjected to immersion coating in coating tank 6. After being pulled out of the coating tank, the cylindrical conductive base body enters solvent vapor pool chamber 11 where a large amount of solvent vapor are discharged from the coated layer and are sent to next drying hood 14 to be dried to the state of finger touch dryness (the state of no stickiness in finger touch). By providing outlet 12 between the solvent vapor pool 11 and the drying hood 14, it is possible to discharge a large amount of solvent vapor while keeping the concentration of solvent vapor in the solvent vapor pool chamber 11 to be uniform totally, even when using a solvent of high saturated vapor pressure as a coating solution and even when forming a coated layer of 50 μm or more that discharges a large amount of solvent vapor, thus, occurrence of uneven finger touch drying of the coated layer and an increase of thin layer start are prevented.

The solvent vapor pool chamber, in this case, is a chamber wherein a coated layer is covered and solvent vapor discharged from a coating solution and from a coated layer are made to be stagnant once so that solvent vapor concentration keeps a uniform ambiance. It is preferable that a height of the solvent vapor pool chamber is 1 cm-100 cm. When it is less than 1 cm, an effect of providing the solvent vapor pool chamber is small, and an effect of prevention of occurrence of layer thickness unevenness is small. Even when it is greater than 100 cm, on the other hand, an effect corresponding to a large-sized apparatus cannot be obtained.

The outlet is formed between the solvent vapor pool chamber and the drying hood so that it surrounds the cylindrical conductive base body when the coated base body is pulled up. Namely, it is preferable to install the outlet 12 between the solvent vapor pool chamber and the drying hood with a clearance of 0.1-10 mm in width. When the clearance is less than 0.1 mm, and amount of solvent vapor ejected is not sufficient, and when it is not less than 10 mm, the solvent vapor pool chamber tends to be affected by a current of external air, and uniformity of solvent vapor concentration in the solvent vapor pool chamber tends to be disturbed accordingly, although ejection of solvent vapor is sufficient.

On the top cover portion of the solvent vapor pool chamber, there is provided an opening portion (hole) which is necessary to make the cylindrical conductive base body to pass through. It is preferable that the opening portion is in a circular form in the same way as in the cylindrical conductive base body.

Further, a length of the drying hood (having the structure to surround the cylindrical conductive base body) installed on the top portion of the solvent vapor-pool chamber is preferably 5 cm-300 cm. If that length is less than 5 cm, and effect of the drying hood is small, resulting in a small effect for preventing occurrence of layer thickness unevenness. If the length is greater than 300 cm, an effect corresponding to a large-sized apparatus cannot be obtained.

It is further preferable to install a recycle tube in the solvent vapor pool chamber, and thereby to keep a liquid level in the coating tank to be constant. Namely, the structure shown in FIG. 1 is preferable. That is, coating solution 1 is sent compulsorily from coating solution tank 2 through supply piping 3 by pump 4, and is supplied into coating solution tank 6 through filter 5. The coating solution supplied to the coating solution tank 6 overflows, and is received in coating solution receiving tank 7 provided continuously on the bottom of solvent vapor pool chamber 11 to flow out to recycle tube 8, thus, the coating solution is collected in coating solution tank 2. When conducting immersion coating by using an immersion coating apparatus, cylindrical conductive base body 9 is immersed in coating solution tank 6, and then, when it is pulled up, the coating solution is circulated by a coating solution circulating means so that the coating solution may overflow constantly, for the purpose of holding coating tank liquid level 10 to be constant. Further, on the top of the solvent vapor pool chamber, there is provided outlet 12 that ejects solvent vapor, and the outlet 12 is provided to be higher than the coating tank liquid level 10. On the upper portion of solvent vapor pool chamber 11, there is provided drying hood 14 that is for preventing an influence of a current of external air. In this case, when the outlet 12 is not provided, or when the outlet 12 is provided on the half way of recycle tube 8 that is positioned to be lower than the coating tank liquid level 10 as in TOKKAIHEI No. 8-220786, solvent vapor concentration in the solvent vapor pool chamber 11 cannot be ejected sufficiently when coated layer with a thickness of 50 μm or more that discharges a large amount of solvent vapor is formed, solvent vapor stays around the cylindrical conductive base body, and uneven finger touch drying of the coated layer is caused to increase thin layer start. However, the outlet 12 that ejects solvent vapor is provided at the position that is higher than the coating tank liquid level 10 on the top of the solvent vapor pool chamber, by using the immersion coating apparatus shown in FIG. 1, therefore, it is possible to eject uniformly the solvent vapor on the periphery of the cylindrical conductive base body, resulting in prevention of occurrence of layer thickness unevenness and an increase of the thin layer start, even if a coated layer with a thickness of 50 μm or more is formed.

Examples of the solvent or the dispersing medium to be employed for forming the layer such as the intermediate layer and the photosensitive layer include n-butylamine, diethylamine, ethylenediamine, isopropanolamine, triethanolamine, triethylenediamone, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxoran, dioxane, methyl alcohol, ethyl alcohol, butyl alcohol, i-propyl alcohol, ethyl acetate, butyl acetate, dimethyl sulfoxide, methyl cellosolve and butyl cellosolve. Dichloromethane, 1,2-dichloroethane and methyl ethyl ketone are preferably employed although the solvents are not limited to them. These solvent may be employed singly or in combination of two or more kinds.

An electrophotographic image having high gradation reproducibility and sharpness can be formed by a combination of the foregoing photoreceptor. and the following toner having a uniform shape coefficient and a sharp particle size distribution.

(1) A toner containing toner particles having a shape coefficient within the range of from 1.2 to 1.6 in a ratio of not less than 65% in number of the entire toner particles

When the shape coefficient is less than 1.2, the adhering force between the photoreceptor and the toner is increased so that insufficient cleaning tends to occur since the shape of the toner particle nears true sphere. On the other hand, when the shape coefficient exceeds 1.6, the insufficient cleaning also occurs since the toner particle is crushed and fine particles are easily formed. The toner containing the toner particles having a shape coefficient within the range of from 1.2 to 1.6 in a ratio of not less than 65%, and preferably not less than 70%, in number is a toner containing a large amount of toner particle which shows good cleaning ability and difficultly forms the fine particles. Therefore, suitable image formation and the high cleaning ability, particularly on the occasion of the formation of a solid image, for a long period can be made possible by the use of the combination of such the toner and the photoreceptor according to the invention.

(2) Toner containing toner particles without corner in a ratio of not less than 50% in number

The toner particle without protrusion is a toner particle having substantially no protrusion. The corner is easily crushed by stress and the charge is concentrated at the corner. When the ratio of the toner particles without such the corner is not less than 50% in number, and preferably not less than 70% in number, the fine particles are difficultly caused by the stress with the developer conveying member and the insufficient cleaning caused by the fine particles can be prevented. Consequently, sufficient cleaning properties without damage on the blade edge and noise made by the blade can be held for a long period and good image can be formed by the combination use of such the toner and the photoreceptor according to the invention. Accordingly, the number ratio of the toner particles without corner is preferably not less than 50%, and more preferably not less than 70%.

(3) A toner in which the sum M of the relative frequency ml of the toner particles included in the class of the highest frequency and the relative frequency m₂ of the toner particle included in the class of the secondary high frequency in a histogram is not less than 70%. In the histogram, natural logarithm lnD of the particle diameter of the toner particle D (μm) is measured on the horizontal axis and the particle size frequency base on number classified into plural classes at intervals of 0.23 is measured on the vertical axis.

When the sum M of the relative frequency m₁ and the relative frequency m₂ is not less than 70% in the toner, the size distribution of the toner particle is sharp and the toner image can be stably formed. Consequently, cleaning ability, particularly cleaning ability without toner slipping through cleaning blade, can be held for a long period and image formation can be suitably performed when such the toner is employer in combination with the photoreceptor according to the invention.

(4) A toner having a number variation coefficient in the number size distribution of the toner particles is not more than 27% and a variation coefficient of the shape coefficient of the toner particles of not more than 16% The toner having a number variation coefficient in the number size distribution of the toner particles is not more than 27% and a variation coefficient of the shape coefficient of the toner particles of not more than 16% is excellent in the cleaning ability and the fine line reproducibility, and high quality images can be formed for a long period by the use of such the toner.

The number variation coefficient of the toner particles is not more than 27%, and preferably not more than 25%. The variation coefficient of the shape coefficient of the toner particles is not more than 16%, and more preferably not more than 14%. In such the toner, the distribution of the toner particle shape is become sharp so that the stable image formation is made possible. Consequently, high cleaning ability and suitable image formation can be held for a long period when such the toner is employed in combination with the photoreceptor according to the invention.

Moreover, it is preferable to employ a toner in which toner particles having a shape coefficient of from 1.2 to 1.6 account for nor less than 65% of the entire toner particles and the variation coefficient of the shape coefficient is not more than 16%. Such the toner shows sufficient cleaning ability since the adhering force of the toner particle with the photoreceptor is weak.

By making the content of the toner particles having no corner to not less than 50% in number and controlling the number variation coefficient of the particle size number distribution to not more than 27%, the toner excellent in the cleaning ability and the fine line reproducibility can be obtained by which high quality images can be formed for a long period.

In the toners of the above items (1) through (4), the particle size of the toner is preferably from 3 to 8 μm in the median diameter D50 based on number. When the toner particles are formed by a polymerization method, the particle diameter can be controlled by the concentration of the coagulating agent, the adding amount of the organic solvent, the time for fusing and the composition of the polymer itself.

When the median diameter D50 based on the number is from 3 to 8 μm, the content of the toner particles having excessive adhesiveness to the developer conveying member and that of those having low adhesiveness in the fixing process can be also reduced. Therefore, the developing ability can be stable for a long period and the transfer efficiency is increased so as to improve the quality of fine line and dot image.

Shape coefficient of the toner represents the circular degree of the toner particle, which is represented by the following formula.
Shape coefficient={(Maximum diameter/2)²×π}/Projection area

In the above, the “maximum diameter” is the width of the particle defined by the distance of a pair of parallel line each contacted to different side of the image of the toner particle projected on plane so that the distance of the lines is become largest, and the “projection area” is the area of the projected image of the toner particle on plane.

The shape coefficient is determined by photographing the toner particle with a scanning electron microscope with a magnitude of 2,000 times and analyzing the photograph by Scanning Image Analyzer manufactured by Nihon Denshi Co., Ltd. The determination is carried out with respect to 100 toner particles and calculated according to the above formula.

The toner contains the toner particles having the shape coefficient of from 1.2 to 1.6 in a ratio of not less than 65% in number, and preferably not less than 70% in number.

The method for controlling the shape coefficient is not specifically limited. For example, the followings are applicable, a method in which the toner particles are sprayed in stream of hot air, a method in which impact of mechanical energy is repeatedly applied to the toner particles in a gas phase and a method in which the toner particles are added into a medium not capable of dissolving the particle and subjected to gyration. It is preferable that the shape coefficient is made within the above-mentioned range using the toner produced by a polymerization method

Variation coefficient =(S/K)×100 (in percent) wherein S represents the standard deviation of the shape coefficient of 100 toner particles and K represents the average of said shape coefficient.

Said variation coefficient of the shape coefficient is generally not more than 16 percent, and is preferably not more than 14 percent. By employing the toner having variation coefficient of the shape coefficient to not more than 16 percent in combination with a photoreceptor having specific shape at the end portion, resolution and cleaning characteristics are improved, and therefore, good image having good sharpness with reduced uneven half-tone image is obtained.

In order to uniformly control said shape coefficient of toner as well as the variation coefficient of the shape coefficient with minimal fluctuation of production lots, the optimal finishing time of processes may be determined while monitoring the properties of forming toner particles (colored particles) during processes of polymerization, fusion, and shape control of resinous particles (polymer particles).

Monitoring as described herein means that measurement devices are installed in-line, and process conditions are controlled based on measurement results. Namely, a shape measurement device, and the like, is installed in-line. For example, in a polymerization method, toner, which is formed employing association or fusion of resinous particles in water-based media, during processes such as fusion, the shape as well as the particle diameters, is measured while sampling is successively carried out, and the reaction is terminated when the desired shape is obtained.

Monitoring methods are not particularly limited, but it is possible to use a flow system particle image analyzer FPIA-2000 (manufactured by TOA MEDICAL ELECTRONICS CO., LTD.). Said analyzer is suitable because it is possible to monitor the shape upon carrying out image processing in real time, while passing through a sample composition. Namely, monitoring is always carried out while running said sample composition from the reaction location employing a pump and the like, and the shape and the like are measured. The reaction is terminated when the desired shape and the like is obtained.

The number particle distribution as well as the number variation coefficient of the toner of the present invention is measured employing a Coulter Counter TA-11 or a Coulter Multisizer (both manufactured by Coulter Co.). In the present invention, employed was the Coulter Multisizer which was connected to an interface which outputs the particle size distribution (manufactured by Nikkaki), as well as on a personal computer. Employed as used in said Multisizer was one of a 100 μm aperture. The volume and the number of particles having a diameter of at least 2 μm were measured and the size distribution as well as the median diameter was calculated. The number particle distribution, as described herein, represents the relative frequency of toner particles with respect to the particle diameter.

The number variation coefficient in the number particle distribution of toner is calculated employing the formula described below:
Number variation coefficient=(S/Dₙ)×100 (in percent)
wherein S represents the standard deviation in the number particle size distribution and Dₙ represents the number average particle diameter (in μm).

Methods to control the number variation coefficient are not particularly limited. For example, employed may be a method in which toner particles are classified employing forced air. However, in order to further decrease the number variation coefficient, classification in liquid is also effective. In said method, by which classification is carried out in a liquid, is one employing a centrifuge so that toner particles are classified in accordance with differences in sedimentation velocity due to differences in the diameter of toner particles, while controlling the frequency of rotation.

Specifically, when a toner is produced employing a suspension polymerization method, in order to adjust the number variation coefficient in the number particle size distribution to not more than 27 percent, a classifying operation may be employed. In the suspension polymerization method, it is preferred that prior to polymerization, polymerizable monomers be dispersed into a water based medium to form oil droplets having the desired size of the toner. Namely, large oil droplets of said polymerizable monomers are subjected to repeated mechanical shearing employing a homomixer, a homogenizer, and the like to decrease the size of oil droplets to approximately the same size of the toner. However, when employing such a mechanical shearing method, the resultant number particle size distribution is broadened. Accordingly, the particle size distribution of the toner, which is obtained by polymerizing the resultant oil droplets, is also broadened. Therefore classifying operation may be employed.

The toner particles of the present invention, which substantially have no corners, as described herein, mean those having no projection to which charges are concentrated or which tend to be worn down by stress. Namely, as shown in FIG. 2(a), the main axis of toner particle T is designated as L. Circle C having a radius of L/10, which is positioned in toner T, is rolled along the periphery of toner T, while remaining in contact with the circumference at any point. When it is possible to roll any part of said circle without substantially crossing over the circumference of toner T, a toner is designated as “a toner having no corners”. “Without substantially crossing over the circumference” as described herein means that there is at most one projection at which any part of the rolled circle crosses over the circumference. Further, “the main axis of a toner particle” as described herein means the maximum width of said toner particle when the projection image of said toner particle onto a flat plane is placed between two parallel lines. Incidentally, FIGS. 2(b) and 2(c) show the projection images of a toner particle having corners.

Toner having no corners is measured as follows. First, an image of a magnified toner particle is made employing a scanning type electron microscope. The resultant picture of the toner particle is further magnified to obtain a photographic image at a magnification factor of 15,000. Subsequently, employing the resultant photographic image, the presence and absence of said corners is determined. Said measurement is carried out for 100 toner particles.

Methods to obtain toner having no corners are not particularly limited. For example, as previously described as the method to control the shape coefficient, it is possible to obtain toner having no corners by employing a method in which toner particles are sprayed into a heated air current, a method in which toner particles are subjected to application of repeated mechanical force, employing impact force in a gas phase, or a method in which a toner is added to a solvent which does not dissolve said toner and which is then subjected to application of revolving current.

Further, in a polymerized toner which is formed by associating or fusing resinous particles, during the fusion terminating stage, the fused particle surface is markedly uneven and has not been smoothed. However, by optimizing conditions such as temperature, rotation frequency of impeller, the stirring time, and the like, during the shape controlling process, toner particles having no corners can be obtained. These conditions vary depending on the physical properties of the resinous particles. For example, by setting the temperature higher than the glass transition point of said resinous particles, as well as employing a higher rotation frequency, the surface is smoothed. Thus it is possible to form toner particles having no corners.

As the polymerized toner, the diameter of toner particles is designated as E (in μm). In a number based histogram, in which natural logarithm lnE is taken as the abscissa and said abscissa is divided into a plurality of classes at an interval of 0.23, a toner is preferred, which exhibits at least 70 percent of the sum (M) of the relative frequency (m₁) of toner particles included in the highest frequency class, and the relative frequency (m₂) of toner particles included in the second highest frequency class.

By adjusting the sum (M) of the relative frequency (ml) and the relative frequency (m₂) to be 70 percent or more, the dispersion of the resultant toner particle size distribution narrows. Thus, by employing said toner in an image forming process, it is possible to securely minimize the generation of selective development.

In the present invention, the histogram, which shows said number based particle size distribution, is one in which natural logarithm lnD (wherein D represents the diameter of each toner particle) is divided into a plurality of classes at an interval of 0.23 (0 to 0.23, 0.23 to 0.46, 0.46 to 0.69, 0.69 to 0.92, 0.92 to 1.15, 1.15 to 1.38, 1.38 to 1.61, 1.61 to 1.84, 1.84 to 2.07, 2.07 to 2.30, 2.30 to 2.53, 2.53 to 2.76 . . . ). Said histogram is drawn by a particle size distribution analyzing program in a computer through transferring to said computer via the I/O unit particle diameter data of a sample which are measured employing a Coulter Multisizer under the conditions described below.

(Measurement Conditions)

(1) Aperture: 100 μm
(2) Method for preparing samples: an appropriate amount of a surface active agent (a neutral detergent) is added while stirring in 50 to 100 ml of an electrolyte, Isoton R-11 (manufactured by Coulter Scientific Japan Co.) and 10 to 20 ml of a sample to be measured is added to the resultant mixture. Preparation is then carried out by dispersing the resultant mixture for one minute employing an ultrasonic homogenizer.

Among methods of controlling the shape coefficient, a polymerizing method toner is desirable at a point simple as a production method and a point of excelling in surface uniformity as compared with pulverized toner, etc.

(5) The ratio (Dv50/Dp50) of the 50 percent volume particle diameter (Dv50) to the 50 percent number particle diameter (Dp50) is from 1.0 to 1.15; the ratio (Dv75/Dp75) of cumulative 75 percent volume particle diameter (Dv75) from the largest particle diameter of toner to the cumulative 75 percent number particle diameter (Dp75) from the largest particle diameter of said toner is from 1.0 to 1.20; the ratio of toner particles having a number particle diameter of less than or equal to 0.7×(Dp50), is 10 percent by number or less, based on the total number of toner particles. The 50 percent volume particle diameter (Dv50) is the same as median diameter in volume standard and the 50 percent number particle diameter (Dp50) is the same as median diameter in number standard. The Dp75 means the particle diameter of 75% in number cumulative curve from the largest particle diameter of said toner, and the Dv75 means the particle diameter of 75% from the largest particle diameter obtained from volume cumulative curve of said toner.

The toner is preferably monodispersed in terms of particle size distribution. Further, it is preferable that the ratio (Dv50/Dp50) of the 50 percent volume particle diameter (Dv50) to the 50 percent number particle diameter (Dp50) of the toner is from 1.0 to 1.15. Said ratio is preferably from 1.0 to 1.13.

Further, in order to control the variation range of transferability as well as developability, the ratio (Dv75/Dp75) of the cumulative 75 percent volume particle diameter (Dv75) from the largest particle diameter to the cumulative 75 percent number particle diameter (Dp75) from the largest particle diameter is preferable to be from 1.0 to 1.20, and is preferably from 1.1 to 1.19. In addition, the ratio of toner particles having a number particle diameter of less than or equal to 0.7×(Dp50) is preferable to be 10 percent by number or less based on the total number of toner particles, and is preferably from 5 to 9 percent by number.

In the above characteristic (5), the 50 percent volume particle diameter (Dv50) of the toner according to the invention is preferably from 2 to 8 μm, and is more preferably from 3 to 7 μm. Further, the 50 percent number particle diameter of the toner according to the invention is preferably from 2 to 7.5 μm, and is more preferably from 2.5 to 7 μm. By adjusting said diameter to said range, the effects of the preset invention are more markedly exhibited.

The cumulative 75 percent volume particle diameter (Dv75) or the cumulative 75 percent number particle diameter (Dp75), as described herein, refers to the volume particle diameter or the number particle diameter, each of which is 75 percent with respect to the sum of the total volume or the sum of the total number while accumulating the frequency from the largest particle diameter.

In the invention, said 50 percent volume particle diameter (Dv50), 50 percent number particle diameter (Dp50), cumulative 75 percent volume diameter (Dv75), and cumulative 75 percent number particle diameter (Dp75) can be determined employing a Coulter Multisizer manufactured by Coulter Co. which is connected to a computer system for data analysis manufactured by Coulter Co.

To measure those, a sample dispersion is prepared by: 0.02 g of toner is dispersed into a 20 ml of aqueous solution having pure water and 1% by weight of surfactant(such as EMAR manufactured by Kao Corp.), subsequently ultrasonic wave is applied for 1 minute. The sample dispersion is poured into beaker containing ISOTON II (manufactured by Coulter Co.) in the sample stand until the measuring concentration becomes 10 to 12%. After that, the Dp50, Dv50, Dp75 and Dv75 are measured and calculated by the foregoing apparatus by set the count for 30,000. In the apparatus, the aperture diameter having 100 μm is used.

If there are apparatuses capable to obtain the same result to the foregoing apparatus, it can be employable.

The constituting components of toner and the components of binding resins which constitute said toner, as well as those of these production, will now be described.

The toner according to the invention comprises at least a coloring agent as well as a binding resin. Said toner may be produced employing processes such as pulverization and classification, or employing a so-called polymerization method in which toner is prepared employing resinous particles prepared by polymerizing polymerizable monomers as described below. When said toner is prepared employing said polymerization method, a production method is particularly preferred which comprises a process in which resinous particles are subjected to salting-out/fusion.

Polymerizable monomers employed in the polymerization method comprise radical polymerizable monomers as a component, and if desired, crosslinking agents may be employed. Further, it is preferable that at least one of said radical polymerizable monomers, having an acidic group or a basic group shown below, is incorporated.

(1) Radical Polymerizable Monomers

Radical polymerizable monomer components are not particularly limited and several of the conventional radical polymerizable monomers may be employed. They may be used individually or in combination so as to satisfy the desired characteristics.

Specifically listed are aromatic based vinyl monomers, acrylic acid ester based monomers, methacrylic acid ester based monomers, vinyl ester based monomers, vinyl ether based monomers, monoolefin based monomers, diolefin based monomers, and halogenated olefin based monomers.

Listed as aromatic based vinyl monomers are, for example, styrene based monomers and derivative thereof such as o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene.

Listed as acrylic acid or methacrylic acid ester based monomers are methyl acrylate, ethyl acrylate, butyl acrylate, 2-ethylhexyl-acrylate, cyclohexyl acrylate, phenyl acrylate, methyl methacrylate, ethyl methacrylate, butyl methacrylate, hexyl methacrylate, 2-methylphenyl methacrylate, ethyl β-hydroxyacrylate, propyl y-aminoacrylate, stearyl methacrylate, dimethylaminoethyl methacrylate, and diethylaminoethyl methacrylate.

Listed as vinyl ester based monomers are vinyl acetate, vinyl propionate, and vinyl benzoate.

Listed as vinyl ether based monomers are vinyl methyl ether, vinyl ethyl ether, vinyl isobutyl ether, and vinyl phenyl ether.

Listed as monoolefin based monomers are ethylene, propylene, isobutylene, 1-butene, 1-pentene, and 4-methyl-1-pentene.

Listed as diolefin based monomers are butadiene, isoprene, and chloroprene.

Listed as halogenated olefin based monomers are vinyl chloride, vinylidene chloride, and vinyl bromide.

(2) Crosslinking Agents

In order to improve the characteristics of toner, as added crosslinking agents are radical polymerizable crosslinking agents. Listed as crosslinking agents are those having at least two unsaturated bonds such as divinylbenzene, divinylnaphthalene, divinyl ether, diethylene glycol methacrylate, ethylene glycol dimethacrylate, polyethylene glycol dimethacrylate, and diallyl phthalate.

(3) Polymerizable Monomers having an Acidic Group or a Basic Group

Listed as polymerizable monomers having an acidic group or a basic group are, for example, polymerizable monomers having a carboxyl group, polymerizable monomers having a sulfonic acid group, and primary amine, secondary amine, tertiary amine and quaternary amine based polymerizable monomers.

Listed as polymerizable monomers having a carboxyl group are acrylic acid, methacrylic acid, fumaric acid, maleic acid, itaconic acid, cinnamic acid, monobutyl maleate, and monooctyl maleate.

Listed as polymerizable monomers having a sulfonic acid group are styrenesulfonic acid, allylsulfosuccinic acid, and octyl allyl sulfosuccinate.

These compounds may have a structure of salts of alkali such as sodium and potassium, or salts of alkali earth metals such as calcium.

Listed as radical polymerizable monomers having a basic group are amine based compounds which may include dimethylaminoethyl acrylate, dimethylaminoethyl methacrylate, diethylaminoethyl acrylate, diethylaminoethyl methacrylate, and quaternary ammonium salts of the 4 compounds described above; and 3-diethylaminophenyl acrylate, 2-hydroxy-3-methacryloxypropyltrimethyl ammonium salt, acrylamide, N-butylacrylamide, N,N-dibutylacrylamide, piperidylacrylamide, methacrylamide, N-butylmethacrylamide, N-octadecylacrylamide; vinylpyridine, vinylpyrrolidone; vinyl N-methylpyridinium chloride, vinyl N-ethylpyridium chloride, N,N -diallylmethylammonium chloride, and N,N-diallylethylammonium chloride.

Regarding the radical polymerizable monomers employed in the invention, the radical polymerizable monomers having an acidic group or a basic group are preferably employed in an amount of 0.1 to 15 percent by weight based on the total of said monomers. Radical polymerizable crosslinking agents are preferably employed in an amount of 0.1 to 10 percent by weight based on the total radical polymerizable monomers, even though said amount may vary depending on their characteristics.

(Chain Transfer Agents)

With the purpose of adjusting the molecular weight, commonly employed chain transfer agents may be used. Chain transfer agents are not particularly limited, and for example, octylmercaptan, dodecylmercaptan, tert-dodecylmercaptan, n-octyl-3-mercaptopropionic acid ester, carbon tetrabromide, and styrene dimer, may be employed.

(Polymerization Initiators)

Radical polymerization initiators, employed in the invention, when they are water-soluble, may be suitably employed. Listed as said initiators are, for example, persulfate salts (potassium persulfate and ammonium persulfate), azo based compounds (4,4′-azobis-4-cyanovaleric acid and salts thereof, and 2,2-azobis(2-aminodipropane) salts), and peroxides.

Further, if desired, said radical polymerization initiators may be combined with reducing agents and used as redox based initiators. By employing said redox based initiators, polymerization activity increases whereby it is possible to lower polymerization temperature and a decrease in polymerization time can be expected.

Selected as said polymerization temperature may be any reasonable temperature, as long as it is higher than or equal to the lowest radical forming temperature. For example, the temperature range of 50 to 90° C. is employed. However, when polymerization initiators, which work at normal temperature are employed in combination, such as a combination of hydrogen peroxide and a reducing agent (ascorbic acid), it is possible to carry our polymerization at temperature equal to or higher than room temperature.

(Surface Active Agents)

In order to carry out polymerization while using said radical polymerizable monomers, it is necessary to carry out oil droplet dispersion into a water-based medium, employing surface active agents. Surface active agents, which can be employed during said dispersion, are not particularly limited. Listed as suitable examples may be the ionic surface active agents shown below.

Listed as ionic surface active agents are sulfonates (sodium dodecylbenzenesulfonate, sodium arylalkyl polyether sulfonate, sodium 3,3-disulfonediphenyurea-4,4-diazo-bis-amino-8-naphthol-6-sulfonate, and sodium ortho-carboxybenzene-azo-dimethylaniline-2,2,5,5-tetramethyl- triphenylmathane-4,4-diazo-bis-β-naphthol-6-sulfonate), sulfate esters (sodium dodecylsulfate, sodium tetradecylsulfate, sodium pentadecylsulfate, and sodium octylsulfate), and fatty acid salts (sodium oleate, sodium laurate, sodium caprate, sodium caprylate, sodium caproate, potassium stearate, and calcium oleate).

Further, nonionic surface active agents can also be employed. Specifically listed as such are polyethylene oxide, and polypropylene oxide, a combination of polypropylene oxide with polyethylene oxide, esters of polyethylene glycol with higher fatty acids, alkylphenol polyethylene oxide, esters of polyethylene glycol with higher fatty acid, and esters of polypropylene oxide with higher fatty acids.

In the invention, these are mainly employed as an emulsifier during emulsion polymerization, but may be employed in other processes or to achieve other purposes.

(Coloring Agents)

Listed as coloring agents may be inorganic pigments, organic pigments and dyes.

Employed as said inorganic pigments may be any of the several conventional ones known in the art. Specific inorganic pigments will be exemplified below.

Employed as black pigments may be, for example, carbon blacks such as furnace black, channel black, acetylene black, thermal black, and lamp black, and in addition magnetic powders such as magnetite and ferrite.

If desired, these inorganic pigments may be employed individually or in combination. Further, the content of said pigments is from 2 to 20 percent by weight with respect to the weight of polymers, and is preferably from 3 to 15 percent by weight.

When said inorganic pigments are employed as magnetic toner, it is possible to add said magnetite. In this case, from the viewpoint of providing the specified magnetic characteristics, said magnetite is preferably added to toner in an amount of 20 to 60 percent by weight.

Employed as said organic pigments as well as said dyes may be any of the several conventional ones known in the art. Specific organic pigments as well as specific dyes will be exemplified below.

Listed as pigments for magenta or red are C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Listed as pigments for orange or yellow are C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155, and C.I. Pigment Yellow 156.

Listed as pigments for green or cyan are C.I. Pigment Blue 15, C.I. Pigment Blue 15:2, C.I. Pigment Blue 15:3, C.I. Pigment Blue 16, C.I. Pigment Blue 60, and C.I. Pigment Green 7.

Employed as dyes may be C.I. Solvent Red 1, C.I. Solvent Red 49, C.I. Solvent Red 52, C.I. Solvent Red 58, C.I. Solvent Red 63, C.I. Solvent Red 111, and C.I. Solvent Red 122; C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, and C.I. and Solvent Yellow 162; C.I. Solvent Blue 25, C.I. Solvent Blue 36, C.I. Solvent Blue 60, C.I. Solvent Blue 70, C.I. Solvent Blue 93, and C.I. Solvent Blue 95, and these may be employed in combination.

If desired, these organic pigments and dyes may be employed individually or in combination of a plurality of these. The amount of pigments added is commonly from 2 to 20 percent by weight with respect to the weight of polymers, and is preferably from 3 to 15 percent by weight.

Said coloring agents may be subjected to surface modification and subsequently employed. Employed as surface modifying agents may be conventional ones known in the art. Specifically, silane coupling agents, titanium coupling agents, and aluminum coupling agents may be preferably employed.

Toner according to the invention may be employed in combination with releasing agents. For example, employed as releasing agents may be low molecular weight polyolefin waxes such as polypropylene and polyethylene, paraffin waxes, Fischer-Tropsh waxes, and ester waxes. Further, in the invention, ester waxes, represented by General Formula (1) given below, may be preferably employed.
R₁—(OCO—R₂)ₙ General Formula (1)
wherein n represents an integer of 1 to 4, is preferably from 2 to 4, is more preferably from 3 to 4, and is most preferably 4;

R₁ and R₂ each represents a hydrocarbon group which may have a substituent; R₁ has from 1 to 40 carbon atoms, preferably has from 1 to 20 carbons atoms, and more preferably has from 2 to 5 carbons atoms; R₂ has from 1 to 40 carbon atoms, preferably has from 13 to 29 carbons atoms, and more preferably from 12 to 25 carbon atoms.

Specific examples of crystalline compounds, having an ester group according to the invention, are shown below. However, the invention is not limited to these examples.

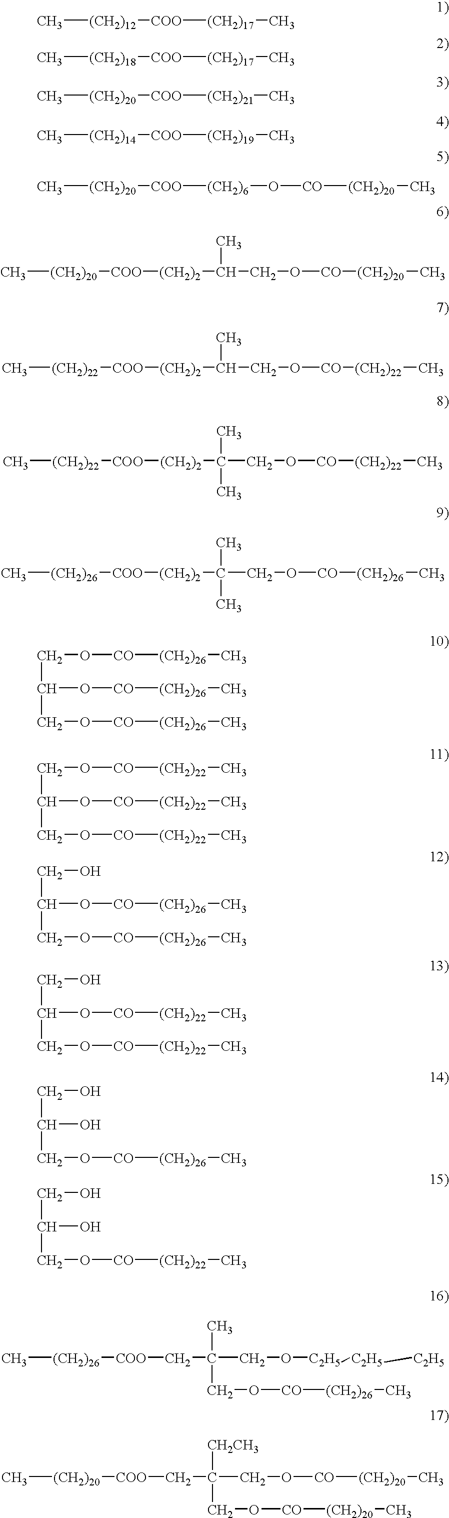

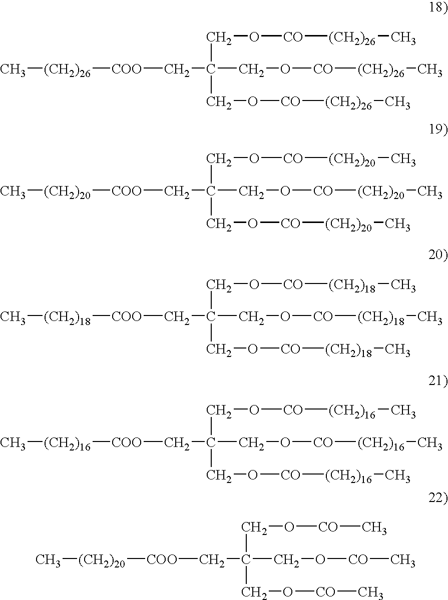

These ester waxes are incorporated into resinous particles and function to provide excellent fixability (adhesion properties to the image receiving member) to the toner which has been prepared by fusing resinous particles.

The content ratio of releasing agents employed in the invention is preferably from 1 to 30 percent by weight, based on the weight of all the toners, is more preferably from 2 to 20 percent by weight, and is further more preferably from 3 to 15 percent by weight. Further, the preferred toner of the invention is prepared as described below. Said releasing agents are dissolved in the aforesaid polymerizable monomers, and the resultant solution is dispersed into water. Subsequently, the resultant dispersion undergoes polymerization, and particles are formed in which the ester based compounds, described above as a releasing agent, are incorporated in the resinous particles. Subsequently, said toner is prepared through a process in which the resultant particles are salted out/fused together with said coloring agent particles.

In addition to said coloring agents and releasing agents, materials, which can provide various functions, may be added as toner materials to the toner according to the invention. Specifically, listed are charge control agents. These components may be added employing various methods such a method in which during the stage of said salting-out/fusion, said components are simultaneously added with said resinous particles as well as said coloring agents so that said components are included in toner particles, and a method in which said components are directly added to said resinous particles.

In the same manner, it is possible to employ various charge control agents, known in the art, and can be dispersed into water. Listed as specific examples are nigrosine based dyes, metal salts of naphthenic acid or higher fatty acids, alkoxylated amines, quaternary ammonium salts, azo based metal complexes, metal salicylates or metal complexes thereof.

External agents employed in the toner according to the invention will now be described.

For the purpose of improving fluidity and chargeability, as well as of enhancing cleaning properties, so-called external additives may be employed via addition to the toner according to the invention. These external additives are not particularly limited, but various fine inorganic and organic particles, as well as slipping agents can be employed.

Employed as fine inorganic particles may be any of the several conventional ones known in the art. Specifically, fine particles of silica, titanium, and alumina may be preferably employed. As said fine inorganic particles, hydrophobic ones are preferred. Listed as specific fine silica particles are commercially available products such as R-805, R-976, R-974, R-972, R-812, and R-809, manufactured by Nippon Aerosil Co.; HVK-2150 and H-200, manufactured by Hoechst Co.; and TS-720, TS-530, TS-610, H-5, and MS-5, manufactured by Cabot Co.

Listed as fine titanium particles are, for example, commercially available products such as T-805 and T-604, manufactured by Nippon Aerosil Co.; MT-100S, MT-100B, MT-500BS, MT-600, MT-600SS, and JA-1, manufactured by Teika Co.; TA-300SI, TA-500, TAF-130, TAF-510, and TAF-510T, manufactured by Fuji Titan Co.; IT-S, IT-OA, IT-OB, and IT-OC, manufactured by Idemitsu Kosan Co.

Listed as fine alumina particles are, for example, commercially available products such as RFY-C, manufactured by Nippon Aerosil Co. and TTO-55, manufactured by Ishihara Sangyo Co.

Further, employed as fine organic particles may be spherical ones having a number average primary particle diameter of about 10 to about 2,000 nm. Employed as materials for such fine organic particles may be homopolymers of styrene and methylmethacrylate and copolymers thereof.

Listed as slipping agents are, for example, salts of higher fatty acids such as salts of stearic acid with zinc, aluminum, copper, magnesium, and calcium; salts of oleic acid with zinc, manganese, iron, copper, and magnesium; salts of palmitic acid with zinc, copper, magnesium, and calcium; salts of linoleic acid with zinc and calcium; as well as salts of ricinolic acid with zinc and calcium.

The content ratio of these external additives is preferably from 1 to 5 percent by weight with respect to the toner.

Listed as units which are employed to add said external additives are various mixers, known in the art, such as a tubular mixer, a Henschel mixer, a Nauter mixer, and a V type mixer.

The production method of the toner is described below.

The polymerized toner can be produced by a method in which fine polymer particles are produced by a suspension polymerization method or an emulsion polymerization method in which a monomer is emulsified in a liquid containing an emulsion of a necessary additive, and then an organic solvent and a coagulating agent are added for associate the fine particles. A method in which the fine polymer particles are mixed on the occasion of the association with dispersion of a parting agent and a colorant necessary for constituting the toner and then association is carried out, and a method in which the toner constitution components such as the parting agent and the colorant are dispersed in the polymerizable polymer and the resultant monomer mixture are emulsified and polymerized are applicable. The association means that plurality of resin particle and the colorant particle are fused.

The colorant and, according to necessity, various constituting materials such as the parting agent a charge controlling agent and a polymerization initiator are added to a polymerizable monomer and dissolved or dispersed by the use of a homogenizer, sand mill., sand grinder or a ultrasonic disperser. The polymerizable monomer or monomers in which the various constituting materials are dissolved or dispersed are dispersed into oil droplets having the suitable size for the toner in an aqueous medium containing a dispersion stabilizer by a homo-mixer or homogenizer. After that, the dispersion is moved into a reaction vessel having the later-mentioned stirring wing as the stirring mechanism, and the polymerization reaction is progressed by heating. After completion of the reaction, and the particles are filtered and washed for removing the dispersion stabilizer and dried to prepare the toner.

Moreover, a method in which the resin particles are associated or fused in an aqueous medium can be applied. Though the method is not specifically limited, those disclosed in Japanese Patent Publication Open to Public Inspection Nos. 5-265252, 6-329947 and 9-15904 are applicable. The toner can be produced by a method in which dispersed particles of the constituting materials such as the resin particles and the colorant or a plurality kinds of fine particles each constituted by the resin and the colorant are associated, particularly by a method in which such the particles are dispersed in water using a emulsifying agent and the coagulating agent is added to the dispersion in a concentration larger than the critical coagulation concentration for salting out the particles, and the dispersion is simultaneously heated by a temperature higher than the glass transition point of the formed polymer for forming and gradually growing fused particles. And then the growing of the fused particle is stopped by addition of a large amount of water when the diameter of the particle is attained at the objective value. Furthermore, the dispersion is heated and stirred to control the shape of the particle so that the surface of the particle is made smooth, and the particles was heated and dried in the fluid state containing water. Thus the toner can be produced. In the above case, a water-miscible organic solvent may be added together with the coagulating agent.

Raw materials, method and polymerization reacting equipment for producing the toner containing the toner particles having a uniform shape coefficient are described in detail in Japanese Patent Publication Open to Public Inspection No. 2000-214629.

The toner is preferably produced by the method comprising a process in which the polymerizable monomer or the polymerizable monomer solution is dispersed in an aqueous medium and polymerized to prepare resin particles including the parting agent; a process for fusing the resin particles in the aqueous medium using the above-prepared resin particle dispersion; a washing process for filtering the resultant particles and removing the surfactant; a process for drying the washed particles; and an external additive adding process for adding an external additive to the dried particles. Thus obtained resin particle may be a colored particle. A non-colored particle may be employed as the resin particle. In such the case, the colored particle can be formed by adding a dispersion of colorant particle to the dispersion of the resin particle and fusing the both kinds of particles.

As the method for fusing, a method is particularly preferred in which the resin particles prepared by the polymerization method are salted out/fused. When the non-colored resin particles are employed, the resin particles and the colorant particles can be salted out/fused in the aqueous medium.

Moreover, the constituting component of the toner, other than the colorant and the parting agent, such as the charge controlling agent can be added in a particle state in the above process.

The aqueous medium is principally composed of water and the content of water is not less than 50% by weight. The water-miscible organic solvent such as methanol, ethanol, iso-propanol, butanol, acetone, methyl ethyl ketone and tetrahydrofuran, can be employed other than water. Alcohol type solvent such as methanol, ethanol, iso-propanol and butanol, are particularly preferred, which are organic solvents capable of not dissolving the resin.

The polymerization method is preferable in which a monomer solution containing the parting agent is dispersed into a state of oil droplets with mechanical energy in an aqueous medium containing a surfactant in a concentration less than the critical micelle formation concentration and a water-soluble polymerization initiator is added to the resultant dispersion for progressing a radical polymerization. In such the case, it is allowed to add an oil-soluble polymerization initiator to the monomer.

Though the dispersing machine for oil droplet dispersing is not specifically limited, for example, CLEAMIX, an ultrasonic disperser, a mechanical homogenizer, Manton-Goulin homogenizer and pressing homogenizer are applicable.

The colorant may be subjected to a surface improving treatment. The surface improving treatment of the colorant is carried out by that the colorant is dispersed in a solvent and a surface improving agent is added to the dispersion and reacted by heating. After completion of the reaction, the colorant is filtered and repeatedly subjected to washing and filtering with the same solvent and then dried to obtain the pigment treated by the surface improving agent.

The colorant particle is prepared by dispersing the colorant in an aqueous medium. The dispersing treatment is preferably carried out in water containing a surfactant in a concentration larger than the critical micelle concentration (CMC).

Though the dispersing machine for oil droplet dispersing is not specifically limited, for example, a pressing type dispersing machine such as CLEAMIX, an ultrasonic disperser, a mechanical homogenizer, Manton-Goulin homogenizer and pressing homogenizer and a medium type dispersing machine such as a sand grinder, Getzman Mill and a diamond fine mill are applicable.

The foregoing surfactants can be used here. In the process for salting out/fusing, the salting out agent composed of an alkali metal salt or an alkali-earth metal salt is added in a concentration larger than the critical coagulation concentration to water containing the resin particles and the colorant particles and then the system is heated by a temperature higher than the glass transition point of the resin particles so as to simultaneously progress the salt out and the fusion of the particles.

In the alkali metal salts and the alkali-earth metal salts employed as the coagulation agent, lithium, potassium and sodium as the alkali metal, and magnesium, calcium, strontium and barium as the alkali-earth metal are usable. Chloride, bromide, iodide, carbonate and sulfate of the above metals are employable.

Though the method for obtaining the particle size distribution of the toner is not specifically limited, for example, a method by classification, a method by controlling the temperature or the time on the occasion of the association and a method by controlling the stopping condition for completing the association are applicable.

The method is particularly preferable in which the association time, association temperature or the stopping rate in water is controlled. Therefore, in the case of slating out/fusion method is applied, it is preferable that the standing time after the addition of the coagulation agent is made as short as possible. Though the reason of such the fact is not cleared, the coagulation state of the particles is varied depending on the standing time after the salting out so as to pose problems such as that the size distribution is made instable and the surface property of the fused toner particle is varied. The temperature at the addition of the coagulation agent is not specifically limited.

It is preferable that the temperature of the dispersion of the resin particle is raised as rapid as possible by a temperature higher than the glass transition point of the resin. The time for raising the temperature is less than 30 minutes and preferably less than 10 minutes. It is necessary to raise the temperature as rapid as possible, and the raising rate is preferably not less than 1° C./minute. Though the lower limit of the rate is not cleared, a rate of not more than 15° C./minute is preferred from the viewpoint of preventing the formation of coarse particles caused by excessively rapid progressing of the salt out/fusion. In the particularly preferred embodiment, the salt out/fusion is continuously progressed after the temperature is reached at a temperature higher than the glass transition point. By such the method, the fusion is effectively progressed together with the growing of the particles and the durability of the final toner can be improved.

The particle diameter can be effectively controlled by employing the di-valent metal salt for salting out/fusing on the occasion of the association. Though the reason of such the fact is not cleared, it is supposed that the repulsive force at the time of salting out is increased by the use of the divalent metal salt so that the dispersing effect of the surfactant can be effectively inhibited and the particle size distribution can be controlled.

The addition of the mono-valent metal salt and water is preferable for stopping the salt out/fusion. The salting out can be stopped by the addition of such the materials so that the formation of the particles having large diameter or small diameter can be controlled.

In the polymerized toner formed by the association or fusion of the resin particles in the aqueous medium, the shape distribution and the shape of the entire toner can be optionally varied by controlling the stream of the medium and the temperature distribution in the reaction vessel in the fusing process and the heating temperature, the rotating number of stirrer and the time in the shape controlling process after the fusion.

In the polymerized toner produced by the association or the fusion of the resin particles, the toner having the shape coefficient and the uniform shape distribution according to the invention can be formed by controlling the temperature, rotating number of the stirrer and the time in the fusing and shape controlling processes in which a stirring wing and a stirring tank are used, by which the stream of the dispersion can be made to laminar flow and the temperature distribution in the tank can be made uniform. It is supposed that, when the fusion is carried out in the laminar flowing field, the particles in the course of the association and fusion are not subjected to strong stress and the temperature distribution in the stirring tank is uniform in the presence of the laminar flow in which the flowing rate is accelerated so that the shape distribution of the fused particles is become uniform. Furthermore, the shape of the fused particle is gradually made sphere by heating and stirring in the following shape controlling process, and the shape of the particle can be optionally controlled.

It is preferable that the salting out and the fusing are simultaneously progressed for controlling the toner to the designated shape. By the method in which the coagulated particles are heated after the coagulation, the distribution of the shape tends to be wide and the formation of fine particle cannot be inhibited. It is supposed that the coagulated particle is re-divided and the fine particles are easily formed since the coagulated particle is heated in the aqueous medium while subjected to be stirred.

(Developer)

Although one component developer or two-component developer is sufficient as toner, the two-component developer is preferable.

When using as one component developer, there may be a method of using the above-mentioned toner as it is as a nonmagnetic one component developer, but usually, toner particles is made to contain about 0.1-5-micrometer magnetic particle and used as a magnetic one component developer. As the containing method, it is common to make it contain in aspherical form particles as same as a colorant.

Moreover, it can be used as a two-component developer by being mixed with carrier. In this case, a well-known material is used as a magnetic particle of a carrier, such as an alloy of metals, such as iron, ferrite, and magnetite, and metals, such as an aluminum and lead. Especially ferritic particles are desirable. The magnetic particle is preferably one having a volume average particle diameter of from 15 to 100 μm, and more preferably from 25 to 60 μm.

The measurement of the volume average particle diameter (D4) can be performed by a laser diffraction particle size distribution measuring apparatus HELOS, manufactured by Sympatec Co., Ltd., having a wet type dispersion means.

As the carrier, a magnetic particle coated with resin and a resin dispersed type carrier composed of magnetic particles dispersed in the resin are preferred. Though the resin composition for coating is not specifically limited, for example, olefin type resins, styrene type resins, Styrene-acryl type resins, silicone type resins, ester type resins or fluorine-containing polymer type resins are employable. As the resin for constituting the resin-dispersed type carrier, known ones can be employed without any limitation, for example, styrene-acryl-type resins, polyester resins, fluorinated type resins and phenol resins are usable.

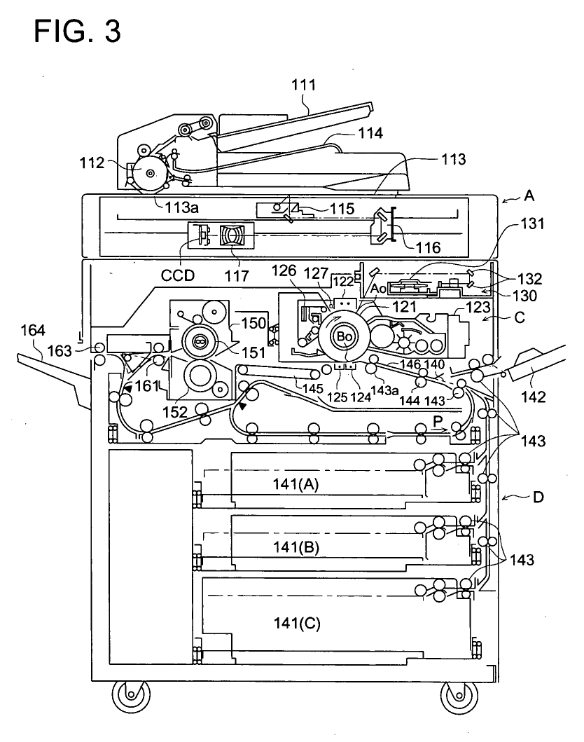

FIG. 3 is a schematic structure diagram showing the entire structure of the image forming apparatus of the invention. The image forming apparatus shown in FIG. 3 is an image forming apparatus of a digital system, and it is composed of image reading section A, image processing section B (illustration omitted), image forming section C and transfer sheet conveyance section D representing a transfer sheet conveyance means.

An automatic document feeding means that conveys a document automatically is provided above the image reading section A, and a document placed on document placing stand 111 is separated and conveyed by document conveyance roller 112 one by one to reading position 113 a where an image is read. The document on which the document reading has been finished is ejected onto document ejection tray 114 by the document conveyance roller 112.

On the other hand, an image of the document placed on platen glass 113 is read by reading actions based on the speed v of the first mirror unit 115 composed of an illumination lamp and a first mirror both constituting a scanning optical system and by movement based on speed v/2 in the same direction of the second mirror unit composed of a second mirror and a third mirror both positioned to be in a V-shape.

The image thus obtained through reading is formed on a light-receiving surface of image sensor CCD representing a line sensor through projection lens 117. Optical images each being in a line form formed on the image sensor CCD are converted photoelectrically into electric signals (luminance signals) in succession, and then; are subjected to A/D conversion, and image data are stored in a memory temporarily, after being subjected to processing such as density conversion and filter processing in the image processing section B.

In the image forming section C, drum-shaped photoreceptor representing an image carrier (hereinafter referred to as photoreceptor) 121, charging unit 122 representing a charging means arranged around the photoreceptor, developing unit 123 representing a developing means, transfer unit 124 representing a transfer means, separating unit 125 representing a separating means, cleaning means 126 having a cleaning blade and PCL (pre-charge lamp) 127 are arranged in the order of each operation. The photoreceptor 121 is one wherein photoconductive compounds are coated and formed on the drum base body, and an organic photoreceptor (OPC), for example, is preferably used, and it is driven to rotate clockwise in the illustration.

Uniform charging is conducted on rotating photoreceptor 121 by the charging unit 122, and then, imagewise exposure based on image signals called from the memory of the image processing section B by exposure optical system 130 is carried out on the rotating photoreceptor 121. The exposure optical system 130 representing a writing means has therein a light-emitting light source representing an unillustrated laser diode, and an optical path passes through rotating polygon mirror 131, fθ lens (having no symbol) and cylindrical lens (having no symbol), and is deflected by reflecting mirror 132 to conduct main scanning, thus, imagewise exposure is conducted at the position of Ao on the photoreceptor 121, and a latent image is formed by rotation (sub-scanning) of the photoreceptor 121. In an example of the embodiment of the invention, imagewise exposure is conducted for the character section so that a latent image is formed.

The latent image on the photoreceptor 121 is subjected to reversal development conducted by developing unit 123, and a visible toner image is formed on the surface of the photoreceptor 121. In the transfer sheet conveyance section D, sheet feeding units 141 (A), 141 (B) and 141 (C) representing a transfer conveyance means in which transfer sheets (paper and plastic) each having a different size are loaded are provided are provided under the image forming unit, further, manual sheet feeding unit 142 that conducts manual sheet feeding is provided on the side, and transfer sheet P selected from any one of them is fed by guide roller 143 along conveyance path 140, then, the transfer sheet is stopped temporarily by paired registration rollers 144 which collect inclination and deviation of the transfer sheet to be fed, and then, sheet feeding is conducted again to be guided by conveyance path 140, pre-transfer roller 143 a and by transfer entry guide plate 146, thus, a toner image on the photoreceptor 121 is transferred onto transfer sheet P at transfer position Bo by transfer unit 124, then, the transfer sheet P is neutralized by separating unit 125 to be separated from the surface of the photoreceptor 121, and is conveyed to fixing unit 150 by conveyance unit 145.

The fixing unit 150 has fixing roller 151 and pressure. roller 152, and when the transfer sheet P is made to pass through the fixing roller 151 and the pressure roller 152, the toner on the transfer sheet P is deposited by heat and pressure. The transfer sheet P on which the fixing of a toner image has been completed is ejected onto sheet ejection tray 164 through rollers 161 and 163.

### EXAMPLES

In the following, this invention will be detailed referring to examples. However, embodiments of this invention are not limited thereto. Herein, “part(s)” in the description means “weight part(s)”.

Example A

The following photoreceptor was prepared as an image carrying member of this invention.

Manufacturing of Photoreceptor 1

Employing an aluminum substrate, having been subjected to a mirror polish process and having a diameter φ of 100 mm and a length of 350 mm, as a conductive substrate, the following intermediate layer, charge generating layer and charge transporting layer were successively coated by use of the immersion coating apparatus described in FIG. 1, followed by being dried resulting in preparation of photoreceptor 1. Herein, coating was performed by setting a gap between a solvent vapor retaining room and a drier hood of the coating apparatus described in FIG. 1 to 2 mm.

Intermediate Layer

A solution of the following composition was dispersed by use of a sand mill homogenizer for 7 hours to prepare an intermediate layer solution.

| | |
|---|---|
| Titanium oxide (titanium oxide having a mean particle | 30 parts |
| diameter of 0.2 μm and being subjected to a primary | |
| treatment by alumina · silica and a secondary | |
| treatment by methyl hydrogenpolysiloxane) | |
| M6401-50 (manufactured by Dainippon Ink & Chemicals, | 16 parts |
| Inc.) | |
| L145-60 (manufactured by Dainippon Ink & Chemicals, | 4 parts |
| Inc.) | |
| Methyl ethyl ketone | 100 parts |

The above intermediate layer solution was coated so as to make a mean dry layer thickness of 4 μm.

Charge Generating Layer

| | |
|---|---|
| Y type titanyl phthalocyanine (titanyl | 60 parts |
| phthalocyanine having the maximum peak at | |
| a Bragg's angle 2θ (±0.2) of 27.2 | |
| degree in measurement of Cu-Kα | |
| characteristic X-ray diffraction spectrum) | |
| Silicone modified butyral resin (X-40-1211M, | 700 parts |
| manufactured by Shin-Etsu Chemical Co., Ltd.) | |
| 2-butanone | 2000 parts |

were mixed and dispersed by use of a sand mill for 10 hours, resulting in preparation of a charge generating layer coating solution. This coating solution was coated on the above-described intermediate layer to form a charge generating layer having a mean dry layer thickness of 0.2 μm.

Charge Transporting Layer

| | |
|---|---|
| Charge transport substance (N-(4-methylphenyl)- | 225 parts |
| N-[4-(β-phenylstyryl)phenyl]-p-toluidine) | |
| Polycarbonate (a viscosity average molecular | 300 parts |
| weight of 30,000) | |
| Anti-oxidant (exemplary compound 1-3) | 6 parts |
| Dichloromethane | 2000 parts |

were mixed and dissolved to prepare a charge transporting layer coating solution. This coating solution was coated on the above-described charge generating layer to form a charge transporting layer having a mean dry layer thickness of 25 μm.
Manufacturing of Photoreceptors 2-8

Photoreceptors 2-8 were manufactured under the same conditions as in manufacturing of photoreceptor 1, except that the conditions of a type and an amount of titanium oxide and of a gap width of a coating apparatus were varied as described in table 1. A (PWS/P²) and a layer thickness deviation of photoreceptors 1-8 obtained in such a manner were measured by the method described above and the results are shown in table 1. Herein, an image forming width of the photoreceptor is 305 mm based on a width in the cylindrical substrate axis direction in the case of an evaluation machine of Konica Digital Copier 7060 which will be described later.

TABLE 1

| | Titanium Oxide in | | | | | | |
|---|---|---|---|---|---|---|---|
| | Intermediate Layer | | | | | | |
| | Number | | | | | | |
| | Average | | | | | | |
| | Primary | | | | | | |
| Photo- | Particle | | | Gap Width of | | Layer | |
| receptor | Diameter | Surface | Amount | Coating | PWS/P² | Thickness | |
| No. | (μm) | Treatment | (parts) | Apparatus | (10⁻⁴ mm⁻¹) | Deviation (μm) | Remarks |
| 1 | 0.2 | A | 30 | 2 | 0.9 | 1.8 | Invention |
| 2 | 0.2 | A | 30 | 1 | 0.9 | 1.4 | Invention |
| 3 | 0.2 | A | 30 | 0 | 0.85 | 2.5 | Invention |
| 4 | 0.2 | A | 10 | 1 | 4.5 | 1.4 | Invention |
| 5 | 0.2 | A | 5 | 1 | 5.3 | 1.4 | Out of Invention |
| 6 | — | — | 0 | 1 | 7.6 | 1.4 | Out of Invention |
| 7 | 0.05 | B | 30 | 2 | 2.1 | 1.8 | Invention |
| 8 | 0.4 | C | 40 | 2 | 0.45 | 1.8 | Invention |

In the above table, A, B and C represent the following surface treatments.
A: a primary treatment by alumina-silica and a secondary treatment by methyl hydrogenpolysiloxane,
B: a primary treatment by alumina-zirconia and a secondary treatment by octyltrimethoxysilane,
C: a primary treatment by alumina-silica and a secondary treatment by fluoromethyltrimethoxysilane

The following toners were prepared.

Manufacturing of Toners T1 and T2 (Example of Emulsion Polymerization Method)

Sodium n-dodecylsulfate of 0.90 kg and 10.0 L of pure water were charged in a vessel and dissolved while being stirred. This solution was gradually added with 1.20 kg of Regal 330R (carbon black manufactured by Cabot Corp.) and was sufficiently stirred for 1 hour, followed by being continuously dispersed by use of a sand grinder (a medium type homogenizer) for successive 20 hours. The resulting solution is designated as “colorant dispersion 1”. While a solution comprising 0.055 kg of sodium dodecylbenzene sulfonate and 4.0 L of ion-exchanged water is designated as “anion surfactant solution A”.

A solution comprising 0.014 kg of a nonylphenol polyethyleneoxide 10 mol adduct and 4.0 L of ion-exchanged water is designated as “nonion surfactant solution B”. A solution comprising 223.8 g of potassium persulfate being dissolved in 12.0 L of ion-exchanged water is designated as “initiator solution C”.

A Wax emulsion (polypropylene emulsion having a number average molecular weight of 3000: a number average primary particle diameter=120 nm/a solid content=29.9%) of 3.41 kg, the whole amount of “anion surfactant solution A” and the whole amount of “nonion surfactant solution B” were charged in a 100 L GL (glass lining) reaction vessel equipped with a thermosensor, a condenser and a nitrogen introducing device, to start stirring. Next, 44.0 L of ion-exchanged water were added.

Heating was started and the whole amount of “initiator solution C” was added drop-wise when the solution temperature reached 75° C. Thereafter, 12.1 kg of styrene, 2.88 kg of n-butyl acrylate, 1.04 kg of methacrylic acid and 548 g of t-dodecyl mercaptan were added drop-wise while the temperature was controlled at 75° C.±1° C. After finishing drop-wise addition, the solution temperature was raised to 80° C.±1° C., and the solution was stirred with heating for 6 hours. Then, the solution temperature was cooled down to not higher than 40° C. and stirring was stopped, followed by filtration through Pole Filter resulting in preparation of “latex (1)-A”.

Herein, resin particles in latex (1)-A had a glass transition temperature of 57° C., a softening point of 121° C., a weight average molecular weight of 12,700 as a molecular weight distribution, and a weight average particle diameter of 120 nm.

Further, a solution in which 0.055 kg of sodium dodecylbenzene sulfonate were dissolved in 4.0 L of ion-exchanged water is designated “anion surfactant solution D”. And, a solution in which 0.014 kg of a nonylphenol polyethyleneoxide 10 mol adduct were dissolved in 4.0 L of ion-exchanged water, was designated “nonion surfactant solution E”.

A solution comprising 200.7 g of potassium persulfate (manufactured by Kanto Chemicals Co., Ltd.) being dissolved in 12.0 L of ion-exchanged water was designated as “initiator solution F”.

A wax emulsion (polypropylene emulsion having a number average molecular weight of 3000: a number average primary particle diameter=120 nm/a solid content=29.9%) of 3.41 kg, the whole amount of “anion surfactant solution D” and the whole amount of “nonion surfactant solution E” were charged in a 100 L GL reaction vessel, equipped with a thermosensor, a condenser, a nitrogen introducing device and a sieve-type baffle, to start stirring. Next, 44.0 L of ion-exchanged water were added to the solution. Heating was started and the whole amount of “initiator solution F” was added when the solution temperature reached 70° C. Thereafter, a solution, in which 11.0 kg of styrene, 4.00 kg of n-butyl acrylate, 1.04 kg of methacrylic acid and 9.02 g of t-dodecyl mercaptan having been mixed in advance, was added drop-wise. After finishing drop-wise addition, heating and stirring were performed for 6 hours while controlling the solution temperature at 72° C.±2° C. Further, the solution temperature was raised to 80° C.±2° C., and stirred with heating for 12 hours. Then, the solution temperature was cooled down to not higher than 40° C. and stirring was stopped, followed by filtration through Pole Filter resulting in preparation of “latex (1)-B”.

Herein, resin particles in latex (1)-B had a glass transition temperature of 58° C., a softening point of 132° C., a weight average molecular weight of 245,000 as a molecular weight distribution and a weight average particle diameter of 110 nm.

A solution comprising 5.36 kg of sodium chloride being dissolved in 20.0 L of ion-exchanged water was designated as “sodium chloride solution G”.

A solution comprising 1.00 kg of fluorine type nonion surfactant being dissolved in 1.00 L of ion-exchanged water was designated as “nonion surfactant solution H”.

Latex (1)-A of 20.0 kg, latex (1)-B of 5.2 kg, 0.4 kg of colorant dispersion 1 and 20.0 kg of ion-exchanged water were charged in a 100 L SUS reaction vessel, equipped with a thermosensor, a condenser, a nitrogen gas introducing device and a monitoring apparatus of a particle diameter and a shape, and stirred. Then, the solution was heated to 40° C., and added with 6.00 kg of isopropanol (manufactured by Kanto Chemicals Co., Ltd.) and nonion surfactant solution H in this order. Thereafter, heating of the solution, which had been kept for 10 minutes, was started to raise the solution temperature to 85° C. in 60 minutes, and particle growth was performed while being salting out/fused by heating and stirring at 85°±2° C. for 0.5-3 hours. Next, particle growth was stopped by addition of 2.1 L of pure water.

Fused particle dispersion of 5.0 kg prepared above was charged in a 5 L reaction vessel, equipped with a thermometer, a condenser, a monitoring apparatus of a particle diameter and a shape, and the solution was heated and stirred at a solution temperature of 85±2° C. for 0.5-15 hours to control the particle shape. Thereafter, the solution was cooled down to not higher than 40° C. and stopped stirring. Next, classification in the solution was performed by a centrifugal precipitation method by using a centrifugal separator, and the filtrate having been filtered through a sieve provided with a 45 μm mesh was designated as association solution (1). Then, non-spherical particles in a wet cake state were obtained as a filtrate from association solution (1) by use of a Nutsche funnel. Thereafter the products was washed with ion-exchanged water.

This non-spherical particles were dried by use of a flush dryer at a suction air temperature of 60° C., followed by being dried by use of a fluid bed dryer at 60° C. Silica micro-particles of 1 weight part and 0.1 part of zinc stearate were externally added and mixed to 100 parts of the obtained colored particles by use of a Henschel mixer, resulting in preparation of toners by an emulsion association method as shown in the following table. In monitoring the aforesaid salting out/fusing stage and shape control process, the shape and the coefficient of variation of a shape factor were controlled by controlling the stirring rotation number and heating time, and the particle diameter and the coefficient of variation of a particle distribution were adjusted by classification in the solution, resulting in preparation of toner T1 and toner T2 shown in table 2.

Preparation of Toner T3 (Example of Suspension Polymerization Method)

Styrene of 165 g, 35 g of n-butyl acrylate, 10 g of carbon black, 2g of a dibutylsalicylic acid metal compound, 8 g of a styrene-methacrylic acid copolymer and 20 g of paraffin wax (mp=70° C.) were heated to 60° C. and uniformly dissolving dispersed by use of a TK mixer (produced by Tokushu Kikakogyo Co.,. Ltd.) at 12000 rpm, to which 10 g of 2,2′-azobis(2,4-valeronitrile) were added and dissolved, resulting in preparation of a polymerizable monomer composition. Successively, 450 g of 0.1 M sodium phosphate aqueous solution were added into 710 g of ion-exchanged water, and 68 g of 1.0 M potassium chloride solution were gradually added thereto while being stirred by use of a TK homomixer at 13000 rpm, resulting in preparation of a suspension comprising tricalcium phosphate being dispersed. The above polymerizable monomer composition was added to this suspension and the resulting system was stirred by a TK homomixer for 20 minutes to make the polymerizable monomer composition into particles. Thereafter, reaction of the system was performed by use of a reaction apparatus provided with a stirring fan at 75-95° C. for 5-15 hours. The product was subjected to classification in the solution by a centrifugal precipitation method by use of a centrifugal separator, followed by filtration, washing-and drying. Silica micro-particles of 1 weight part and 0.1 weight part of zinc stearate were externally added and mixed by use of a Henschel mixer, resulting in preparation of a toner by a suspension polymerization method.

Monitoring was performed during the above polymerization, and the shape and the coefficient of variation of a shape factor were controlled by controlling the solution temperature, the stirring rotation number and heating time, and further the particle diameter and the coefficient of variation of a particle distribution were adjusted by classification in the solution, resulting in preparation of toner T3 shown in following Table 2.

TABLE 2

| | | | Coefficient | | | Coefficient | | |
|---|---|---|---|---|---|---|---|---|
| | Ratio (%) | Ratio (%) | of variation | Ratio of | | of variation | | |
| | of Shape | of Shape | of Shape | Toner Particle | Number Average | of Number | | |
| Toner | Coefficient | Coefficient | Coefficient | Having No | Particle Diameter | Distribution | Sum M (%) of | Production |
| No. | of 1.0 to 1.6 | of 1.2 to 1.6 | (%) | Corner (%) | (μm) | (%) | m₁ and m₂ | Method |
| Toner T1 | 76.6 | 72.0 | 14.9 | 53 | 6.4 | 26.2 | 77.0 | Emulsification |
| | | | | | | | | Polymerization |
| Toner T2 | 75.7 | 70.6 | 15.3 | 58 | 6.3 | 25.8 | 78.1 | Emulsification |
| | | | | | | | | Polymerization |
| Toner T3 | 89.5 | 76.9 | 14.8 | 61 | 8.9 | 26.6 | 77.8 | Suspension |
| | | | | | | | | polymerization |

(Preparation of Developer)
Production of developer 1

To 100 parts of the above-mentioned toner T1 and 0.4 parts of hydrophobic silica particles (R805: made by a Japanese Aerosil Company) with an average particle diameter of 12nm and 0.6 parts of titania particles (T805: made by a Japanese Aerosil Company) were mixed as an external additive agent , further mixed for 10 minutes with the rotor circumferential speed 40 (m/sec) of stirring impellers by the Henschel mixer under normal temperature, and thereby negative chargeable toner was obtained. The adhesion rate of this toner was 45%.

To the above-mentioned toner, ferrite carrier with a volume average particle diameter of 60 μm which was covered with silicone resin was mixed, and thereby developer 1 having the toner concentration of 5% was prepared.

Production of Developers 2 and 3

In production of the above-mentioned developer 1, except that toner T2 was used instead of toner T1, developer 2 was prepared similarly. Moreover, except that toner T3 was used instead of toner T1, developer 3 was prepared similarly.

Evaluation

The photoreceptor and developer which were obtained above were combined as shown in Table 3 (combination No. 1-14), and were evaluated using the evaluating machine constructed based on a Konica digital process copying machine 7060.

Conditions of the Above-Mentioned Evaluating Machine

Circumferential speed of photoreceptor; 370 mm/sec

Charging device; Scorotron charging device, an initial charging potential was set at −750 V

Exposure Condition

Imagewise-exposure light: Semiconductor laser (680nm), an exposure amount was set such that a light exposed part potential was set to −50 V.

Developing Condition

DC bias; −550 V
Dsd; 550 μm
Developer layer regulation; edge cut method
Developer layer thickness; 700 μm
Diameter of a developing sleeve; 40 mm
   Transfer Condition

Transfer electrode; corona charging method, transfer dummy electric current value:45 microA

Cleaning Condition

Cleaning blade was brought in contact with line pressure 20 (N/m) in a counter direction (for the rotation direction of photoreceptor)

An original picture image in which character picture image having a pixel rate of 7%, a halftone photographic image, a solid white picture image, and a solid black picture image were formed on a ¼ equal part respectively was copied continuously by 100,000 sheets of A4 papers under normal temperature normal humidity (24 degrees C., 60%RH), and evaluation was conducted for the copies.

Evaluation item and criterion for evaluation are shown as follows.

Evaluation of moire (it evaluated by the copy picture image of the total of 11 sheets for the initial stage and every 10,000-sheet copy.)
A: No moire occurred through 100,000 copies : good
B: Moire occurred slightly only at the initial stage, no problem
C: Moire occurred remarkably at the initial stage or in the course of the evaluation
D: Moire occurred through 100,000 copies

Cleaning ability (continuous 10 sheet-copy was performed on A3 paper every after 10,000 copies was completed, and it was judged by presence/absence of cleaning failure in a solid white part)
A: Picture image unevenness due to blade peeling or unremoved toner with the blade was not occurred on all 100,000 copies picture images: good
B: Slight picture image unevenness due to unremoved toner with the blade was occurred before 100,000 copies picture images: No problem
C: Picture image unevenness due to blade peeling or unremoved toner with the blade was occurred

Resolution (in order to evaluate lowering of the resolution due to occurrence of moire and occurrence of filming to a photoreceptor surface, it was judged by easiness in legibility for a character picture image)
A: There is no difference in the resolution between at the initial stage and after 100,000-sheet copy, good
B: The resolution was slightly lowered between at the initial stage and after 100,000-sheet copy, No problem

C: The resolution was remarkably lowered between at the initial stage and after 100,000-sheet copy

TABLE 3

| | | | Evaluation | | | |
|---|---|---|---|---|---|---|
| Combination | Photoreceptor | Developer No. | | Cleaning | | |
| No. | No | (Toner No.) | Moire | Ability | Resolution | Remarks |
| 1 | 1 | 1(T1) | A | A | A | Inv. |
| 2 | 2 | 1(T1) | A | A | A | Inv. |
| 3 | 3 | 1(T1) | B | C | C | Comp. |
| 4 | 4 | 1(T1) | B | A | B | Inv. |
| 5 | 5 | 1(T1) | D | A | C | Comp. |
| 6 | 6 | 1(T1) | D | A | C | Comp. |
| 7 | 2 | 2(T2) | A | A | A | Inv. |
| 8 | 3 | 2(T2) | B | C | C | Comp. |
| 9 | 5 | 2(T2) | D | B | C | Comp. |
| 10 | 2 | 3(T3) | A | B | A | Inv. |
| 11 | 3 | 3(T3) | B | C | C | Comp. |
| 12 | 5 | 3(T3) | D | B | C | Comp. |
| 13 | 7 | 1(T1) | B | A | B | Inv. |
| 14 | 8 | 1(T1) | A | A | A | Inv. |

From the results of Table 3, in the combination (No. 1, 2, 4, 7, 10, 13, 14) of the organic photoreceptor (No. 1, 2, 4, 7, 8) which had a layer thickness deviation of a covered layer of 0.2-2.0 μm and satisfied Formula 1 and toner particles, occurrence of moire was prevented, cleaning ability and evaluation of a resolution were good. However, in the combination (No. 3, 5, 6, 8, 9, 11, 12) of the organic photoreceptor (No. 3, 5, 6) which had a layer thickness deviation of a covered layer of 2.5 μm and was out of the range of Formula 1 and toner particles, the moire occurred remarkably. As a result, the resolution was lowered.

(Preparation of Latex 1)

In a 5000 ml separable flask with which a stirring device, a temperature sensor, a cooling tube, and a nitrogen introducing device were attached, a solution in which 7.08 g of a anion surfactant (sodium dodecylbenzene sulfonate:SDS) was dissolved in 2760 g of ion exchanged water was prepared. Under the nitrogen air current, the temperature in a flask was raised to 80° C., while agitating the solution at the stirring velocity of 230 rpm. On the other hand, 72.0 g of an exemplification compound 19 was added in a monomer which consists of 115.1 g of styrene, 42.0 g of an n-butylacrylate and 10.9 g of methacrylic acid, was warmed and dissolved at 80 degrees C., thereby a monomer solution was produced. Here, mixed homogenization of the above-mentioned heated solution was mixed and dispersed by a mechanical homogenizer which has a circulation pathway, thereby emulsification particles which have a uniform diameter of a dispersion particle were produced. Subsequently, latex particles were produced by adding a solution in which 0.84 g of a polymerization initiator (potassium persulfate: KPS) into 200 g of ion exchanged water, and heating and agitating at 80 degrees C. for 3 hours. Further, subsequently, an initiator solution composed of 7.73 g of a polymerization initiator (KPS) dissolved in 240 ml of on exchanged water was added, and then 15 minute later, a mixture liquid composed of 383.6 g of styrene, 140 g of n-butyl acrylate, 36.4 g of methacrylic acid and 14.0 g of n-octyl 3-mercaptopropionateester was dropped spending 120 minutes at a temperature of 80° C. After carrying out heating stirring for 60 minutes after the dropping was completed , it cooled to 40 degrees C., thereby latex particles were obtained.

The latex was referred to as Latex 1.

Preparation of Colored Particles

(Preparation of Colored Particles 1Bk)

9.2g of n-sodium dodecyl sulfate was stirred and dissolved into 160 ml of ion exchanged water. 20g of REGAL 330R(carbon black by Cabot Corp.) was gradually added to this liquid under stirring, and, subsequently was dispersed by using CLEAMIX. As a result of measuring the particle size of the above-mentioned dispersion liquid using electrophoresis light-scattering photometer ELS-800 by an OTSUKA ELECTRONICS CO., LTD. company, it was 112 nm in diameter of a weight average. This dispersion liquid was referred as “Colorant Dispersion Liquid 1.”

1250 g of “Latex 1”, 2000 ml of ion exchanged water, and the above-mentioned “Colorant Dispersion Liquid 1” are put into a 5 liter 4 mouth flask attached with a temperature sensor, a condenser tube, a nitrogen introduction apparatus, and a stirring apparatus, and are agitated. After adjusting to 30 degrees C., five mol/liter of sodium hydroxide aqueous solution was added to this solution, and pH was adjusted to 10.0. After that, a solution of 12.1 g of magnesium chloride hexahydrate in 1,000 ml of deionized water was added to the above liquid spending 10 minutes at 30° C. Then, after leaving it alone for 2 minutes, temperature rising was started and the liquid temperature was raised to 90 degrees C. in 5 minutes (heating rate=12-degree-C./minutes). A particle size was measured with Coulter counter TAII in the state, when volume average particle diameter became to 4.3 μm, an aqueous solution which dissolved 115 g of sodium chloride in 700 ml of ion exchanged water was added, and grain growth was stopped, continuously further, and at 85 degrees C.±2 degrees C. of the liquid temperature, heating stirring was carried out for 8 hours, and a salting-out/fusion was conducted for it. Then, it was cooled to 30 degrees C. on a condition of 6 degrees C./min, hydrochloric acid was added, pH was adjusted to 2.0, and stirring was stopped. The produced coloring particles were filtered /washed on the following condition, after that, it was dried by 40-degree C. warm air, and thereby coloring particles were obtained. This thing was referred as “coloring particle 1Bk.”

(Production of Coloring Particle 2Bk, 3Bk, 4Bk, and 5Bk(s))

In production of coloring particle 1Bk, coloring particle 2Bk-5Bk was similarly manufactured respectively except having changed into production conditions described in Table 2.

(Production of Coloring Particle 6Bk-8Bk)

In production of coloring particle 1Bk, when the production conditions described in Table 4 was set and a volume average particle diameter became 3.8 μm, grain growth was stopped, and thereby coloring particle 6Bk-8Bk was manufactured respectively.

(Production of Coloring Particle 9Bk-11Bk)

In the production of coloring particle 1Bk, the production condition described in Table 4 was set, and when a volume average particle diameter became 0.2-0.3 μm smaller than the last particle size described in Table 5, grain growth was stopped, and thereby coloring particle 9Bk-11Bk was manufactured respectively.

(Production of Coloring Particle 12Bk and 13Bk)

In the production of coloring particle 1Bk, except that when the 50% volume particle size (Dv50) became 2.6 μm and 7.1 μm, grain growth was stopped, coloring particle 12Bk-13BK was manufactured by the same procedure.

The production condition of coloring particles is shown in a Table 4, and each physical properties of the obtained coloring particles is shown in a Table 5.

TABLE 4

| | | Tem- | | |
|---|---|---|---|---|
| | | per- | | |
| | Added | ature | | |
| | amount of | Rising | Salting-out/Fusion | |
| | Magnesium | Speed | | Holding |
| | chloride | (° C./ | Solution | Time |
| Coloring Particle No. | (g) | Min) | Temperature | (Hours) |
| Coloring Particle 1Bk | 52.6 | 12 | 85 ± 2° C. | 8 |
| Coloring Particle 2Bk | 52.6 | 20 | 90 ± 2° C. | 6 |
| Coloring Particle 3Bk | 52.6 | 5 | 90 ± 2° C. | 6 |
| Coloring Particle 4Bk | 26.3 | 12 | 85 ± 2° C. | 8 |
| Coloring Particle 5Bk | 78.9 | 12 | 85 ± 2° C. | 8 |
| Coloring Particle 6Bk | 52.6 | 12 | 85 ± 2° C. | 8 |
| Coloring Particle 7Bk | 43.3 | 12 | 85 ± 2° C. | 8 |
| Coloring Particle 8Bk | 78.9 | 12 | 85 ± 2° C. | 8 |
| Coloring Particle 9Bk | 52.6 | 12 | 85 ± 2° C. | 8 |
| Coloring Particle 10Bk | 35.5 | 12 | 85 ± 2° C. | 8 |
| Coloring Particle 11BK | 78.9 | 12 | 85 ± 2° C. | 8 |

TABLE 5

| | 50% Volume | 50% Number | | Cumulative | Cumulative | | Number % of |
|---|---|---|---|---|---|---|---|
| Coloring | Average | Average | | 70% Volume Average | 70% Number Average | | Particle lower |
| Particle | Particle Diameter | Particle Diameter | | Particle Diameter | Particle Diameter | | than |
| No. | (D_{V}50) (μm) | (Dₚ50) (μm) | D_{V}50/Dₚ50 | (D_{V}75) (μm) | (Dₚ75) (μm) | D_{V}75/Dₚ75 | 0.7x Dₚ50 |
| Coloring | 4.6 | 4.3 | 1.07 | 4.1 | 3.7 | 1.11 | 7.8 |
| Particle 1Bk | | | | | | | |
| Coloring | 4.8 | 4.5 | 1.07 | 4.2 | 3.7 | 1.14 | 5.5 |
| Particle 2Bk | | | | | | | |
| Coloring | 4.5 | 4.1 | 1.1 | 4 | 3.4 | 1.18 | 8.2 |
| Particle 3Bk | | | | | | | |
| Coloring | 4.6 | 3.7 | 1.24 | 4.1 | 3.1 | 1.32 | 13.6 |
| Particle 4Bk | | | | | | | |
| Coloring | 4.7 | 4.3 | 1.09 | 4.1 | 3.6 | 1.14 | 6.3 |
| Particle 5Bk | | | | | | | |
| Coloring | 3.9 | 3.7 | 1.05 | 3.3 | 2.8 | 1.18 | 6.8 |
| Particle 6Bk | | | | | | | |
| Coloring | 3.8 | 3.4 | 1.12 | 3.2 | 2.7 | 1.18 | 11.3 |
| Particle 7Bk | | | | | | | |
| Coloring | 3.9 | 3.8 | 1.03 | 3.3 | 2.8 | 1.18 | 6.3 |
| Particle 8Bk | | | | | | | |
| Coloring | 5.6 | 5.3 | 1.06 | 5.1 | 4.5 | 1.13 | 8.5 |
| Particle 9Bk | | | | | | | |
| Coloring | 5.5 | 4.8 | 1.15 | 4.9 | 4 | 1.23 | 12.5 |
| Particle | | | | | | | |
| 10Bk | | | | | | | |
| Coloring | 5.7 | 5.4 | 1.06 | 5.1 | 4.4 | 1.16 | 6.3 |
| Particle | | | | | | | |
| 11Bk | | | | | | | |
| Coloring | 2.8 | 2.5 | 1.12 | 2.4 | 2.2 | 1.09 | 8.7 |
| Particle | | | | | | | |
| 12Bk | | | | | | | |
| Coloring | 7.3 | 6.9 | 1.06 | 6.5 | 6.0 | 1.08 | 7.0 |
| Particle | | | | | | | |
| 13Bk | | | | | | | |

(Production of Toner Particles)

To each of obtained coloring particle 1Bk-13Bk, 1 weight % of a hydrophobic silica ((the number average first order diameter=12 nm, degree of hydrophobicity=68) and a hydrophobic titanium oxide (the number average first order diameter=20 nm, degree of hydrophobicity=63) were added, was mixed by Henschel mixer, and thereby toner 1Bk-13Bk was obtained.

Physical properties, such as a form of incidentally toner and a particle size, were the same as that of the physical-properties data of the coloring particles shown in a Table 5.

Preparation of Developer

The ferrite carrier with a volume average particle diameter of 60 μm which was covered with a silicone resin was mixed to each of the above-mentioned toner particles, and thereby developers 1Bk-13Bk having the toner concentration of 6% were manufactured respectively.

Evaluation

The photoreceptor and developer which were obtained above were combined as shown in Table 6 (combination No. 1-19), and were evaluated using the evaluating machine constructed based on a Konica digital process copying machine 7060.

The condition of the above-mentioned the evaluating machine evaluation basis were the same as Example A.

TABLE 6

| | | | Evaluation | | | |
|---|---|---|---|---|---|---|
| Combination | Photoreceptor | Developer No. | | Cleaning | | |
| No. | No | (Toner No.) | Moire | Ability | Resolution | Remarks |
| 1 | 1 | 1 | A | A | A | Inv. |
| 2 | 2 | 2 | A | A | A | Inv. |
| 3 | 3 | 3 | B | C | C | Comp. |
| 4 | 5 | 5 | D | B | C | Comp. |
| 5 | 6 | 6 | D | B | C | Comp. |
| 6 | 2 | 8 | A | A | A | Inv. |
| 7 | 3 | 9 | B | C | C | Comp. |
| 8 | 5 | 11 | D | B | C | Comp. |
| 9 | 1 | 12 | A | B | A | Inv. |
| 10 | 2 | 13 | A | A | B | Inv. |
| 11 | 4 | 1 | B | A | B | Inv. |
| 12 | 1 | 5 | A | A | A | Inv. |
| 13 | 1 | 6 | A | A | A | Inv. |
| 14 | 2 | 11 | A | A | A | Inv. |
| 15 | 7 | 1 | B | A | B | Inv. |
| 16 | 8 | 2 | A | A | A | Inv. |

From the results of Table 6, in the combination (No. 1, 2, 8, 12-19) of the organic photoreceptor which had a layer thickness deviation of a covered layer of 0.2-2.0 μm and satisfied Formula 1 and toner particles, occurrence of moire was prevented, cleaning ability and evaluation of a resolution were good. However, in the combination (No. 3, 5, 6, 9, 11) of the organic photoreceptor which had a layer thickness deviation of a covered layer of 2.5 μm and was out of the range of Formula 1 and toner particles, the moire occurred remarkably, the cleaning ability deteriorated. As a result, the resolution was lowered.

As shown in the above example, by using the image forming method of an electro photographic type and an organic photoreceptor, occurrence of the moire at the time of formation of a digital image could be prevented, and an organic photoreceptor, an image forming method, and image formation apparatus capable of having good cleaning ability and obtaining a high-resolution sharp electrophotography picture image, have been offered.

What is claimed is:

1. An organic photoreceptor, comprising:
a base body; and
a covering layer;
wherein a layer thickness deviation of a substantial image forming area of the covering layer is 0.2-2.0 μm, and a relationship between mean value PWS of reflected light amount power spectrum in a range of spatial frequency 0-2 mm⁻¹ measured with exposure wavelength 680 nm and mean value P of an amount of reflected light satisfies the following expression 1:
0<(PWS/P²)<5.0×10⁻⁴ mm⁻¹

2. The organic photoreceptor of claim 1, wherein the relationship between the mean value PWS of reflected light amount power spectrum and the mean value P of an amount of reflected light satisfies the following expression 2:
0<(PWS/P²)<1.0×10⁻⁴ mm⁻¹

3. The organic photoreceptor of claim 1, wherein the covering layer comprises at least an intermediate layer and a photosensitive layer and the intermediate layer contains inorganic particles having a number average particle diameter of 0.02 to 0.5 μm.

4. The organic photoreceptor of claim 1, wherein the inorganic particles includes at least one of copper sulfate, zinc sulfate and titanium oxide.

5. The organic photoreceptor of claim 1, wherein the layer thickness deviation is a deviation measured by an eddy current type layer thickness measuring instrument Fischerscope (made by Fischer Co.), and the value of (PWS/P²) is a value of (PWS/P²) measured by a laser displacement meter LC2400 (made by Keyence Corporation).

6. An image forming method, comprising steps of:
forming an electrostatic latent image on the organic photoreceptor described in claim 1,
developing the latent image with toner having a variation coefficient of a shape coefficient not more than 16% and a number variation coefficient not more than 27% in a number particle size distribution in terms of number so as to form a toner image;
transferring the toner image onto a transfer material and thereafter
removing the residual toner on the photoreceptor.

7. An image forming method, comprising steps of:
forming an electrostatic latent image on the organic photoreceptor described in claim 1,
developing the latent image with toner containing toner particles having a shape coefficient of 1.2 to 1.6 by 65 number % or more so as to form a toner image;
transferring the toner image onto a transfer material and thereafter
removing the residual toner on the photoreceptor.

8. An image forming method, comprising steps of:
forming an electrostatic latent image on the organic photoreceptor described in claim 1,
developing the latent image with toner containing toner particles having no corner by 50 number % or more so as to form a toner image;
transferring the toner image onto a transfer material and thereafter
removing the residual toner on the photoreceptor.

9. An image forming method, comprising steps of:
forming an electrostatic latent image on the organic photoreceptor described in claim 1,
developing the latent image with toner containing toner particles, wherein in a histogram showing a particle size distribution of number base in which a horizontal axis representing a natural logarithm InD where D (μm) represents a particle diameter of the toner particles is classified into plural classes at intervals of 0.23, the sum (M) of the relative frequency (m₁) of toner particles included in the most frequent class and the relative frequency (m₂) of toner particles included in the second most frequent class to the most frequent class is 70% or more;
transferring the toner image onto a transfer material and thereafter
removing the residual toner on the photoreceptor.

10. An image forming method, comprising steps of:
forming an electrostatic latent image on the organic photoreceptor described in claim 1,
developing the latent image with toner containing toner particles, wherein the ratio (Dv50/Dp50) of the 50% volume particle diameter (Dv50) to the 50% number particle diameter (Dp50) is 1.0-1.15, the ratio (Dv75/Dp75) of the accumulation 75% volume particle diameter (Dv75) from the greatest volume particle diameter of the toner to the accumulation 75% number particle diameter (Dp75) from the greatest number particle diameter of the toner is 1.0-1.20, and the number of toner particles in which the particle diameter is not more than 0.7×(Dp50) is 10 number % or less;
transferring the toner image onto a transfer material and thereafter
removing the residual toner on the photoreceptor.

11. The image forming method of claim 8, wherein the relationship between the mean value PWS of reflected light amount power spectrum and the mean value P of an amount of reflected light satisfies the following expression 2:
0<(PWS/P²)<1.0×10⁻⁴ mm⁻¹

12. The image forming method of claim 8, wherein the covering layer comprises at least an intermediate layer and a photosensitive layer and the intermediate layer contains inorganic particles having a number average first order particle diameter of 0.02 to 0.5 μm.

13. The image forming method of claim 8, wherein the toner particles have a 50% volume particle diameter (Dv50) of 2 to 8 μm.

14. The image forming method of claim 8, wherein the ratio (Dv50/Dp50) of the 50% volume particle diameter (Dv50) to the 50% number particle diameter (Dp50) is 1.0 to 1.13.
